(19) United States
(12) Patent Application Publication
(10) Pub. No.: US 2024/0375870 A1
(43) Pub. Date: Nov. 14, 2024

(54) Method and Apparatus for Retaining Items on Material Handling Apparatus Delivery Vehicles

(71) Applicant: OPEX Corporation, Moorestown, NJ (US)

(72) Inventors: Monty McVaugh, Moorestown, NJ (US); Joseph Valinsky, Moorestown, NJ (US); Kerry O'Mara, Moorestown, NJ (US); Michael Shanahan, Moorestown, NJ (US); Gary Miller, Moorestown, NJ (US)

(21) Appl. No.: 18/661,282

(22) Filed: May 10, 2024

Related U.S. Application Data
(60) Provisional application No. 63/465,870, filed on May 11, 2023.

(51) Int. Cl. B65G 1/06; B65G 1/04; B65G 1/137

(52) U.S. Cl. CPC B65G 1/065; B65G 1/0414; B65G 1/0485; B65G 1/1373; B65G 2201/0214; B65G 2205/04

(57) ABSTRACT

Respective items are retained as they are transported by mobile delivery mechanisms. An item to be delivered to a target storage location of a plurality of storage locations is positioned upon the carrying surface of a delivery mechanism. The carrying surface defines a retention zone bounded by a first wall, a second wall, a third wall and a fourth wall. At least one of the third wall or the fourth wall are displaceable to define an opening in the retention zone. The delivery mechanism moves from the location where an item is received to a location proximate the target storage location to facilitate transfer of the item through the opening obtained by displacing one of the third wall or the fourth wall. Irregularly shaped items are free—during movement of the delivery mechanism—to move upon the carrying surface and within the boundaries of the retention zone.

### PRIORITY CLAIM

The present application claims the benefit of priority to U.S. Provisional Patent Application No. 63/465,870 filed on May 11, 2023. The entire disclosure of each of the foregoing applications is hereby incorporated herein by reference.

### FIELD OF THE INVENTION

The present invention relates to a material handling system and in particular to a system operable to receive and sort items using a plurality of automated vehicles.

### BACKGROUND OF THE INVENTION

Sorting and retrieving items to fill a customer order can be a laborious and time consuming. Similarly, many large organizations have extensive storage areas in which numerous items are sorted. In many fields, automated sorting has developed to reduce labor cost and improve customer service by reducing the time it takes to fill a customer order. However, the known systems of automatically handling the materials are either very expensive or have limitations that hamper their effectiveness. Accordingly, there is a need in a variety of material handling applications for automatically sorting items.

The overall throughput of a material handling system that uses such mobile delivery mechanisms as, for example, delivery vehicles, is limited in part by the amount of time it takes to transfer a respective item to each delivery mechanism at an input station, the round-trip time it takes for each delivery mechanism to reach and return from a corresponding target storage location, and the amount of time taken by each delivery mechanism to transfer the respective item to the corresponding target storage location. A continuing need exists for material handling systems such, for example, as item sortation systems, which are capable of handling a wide variety of item shapes and cross sectional profiles, while maintaining as high a level of overall item processing throughput as economically practicable.

### SUMMARY OF THE INVENTION

The aforementioned need is addressed, and an advance is made in the art, by systems and methods capable of sustaining a high level of item processing throughput by enhancing the retention of respective items as they are transported by corresponding mobile delivery mechanisms. In embodiments, irregularly shaped items such, for example, as those having a cross sectional profile characterized by arcuate surface portions (e.g., cylindrically or spherically shaped items) are free—during movement of the delivery mechanisms along an item delivery path path—to move upon a carrying surface of the delivery mechanism, but such movement is constrained to the boundaries of a defeatable retention zone despite changes in the direction and/or velocity of the delivery mechanism. When intact, the defeatable retention zone is bounded by first and second spaced apart lateral side walls of the delivery mechanism and first and second spaced apart retention assistant walls. The retention zone is defeatable in the sense that at least one of the retention assistant walls is displaceable such that it/they can be moved from a first position which extends transversely relative to the lateral side walls to close off a corresponding transfer passage through which an item could otherwise escape the retention zone and a second position which temporarily removes an applicable retention assistant wall as a boundary of the retention zone.

In a first embodiment, each of one or more retention assistant walls of a delivery mechanism are configured as one or more pivotably movable door(s) which are displaceable, relative to a carrying surface of the delivery mechanism, by pivoting from a first position—in which a door is disposed across an item transfer passage to thereby form a boundary of the retention zone to impede movement of an item through the item transfer passage and out of the retention zone—to a second position in which the door is no longer disposed across the item transfer passage and an item being carried by the delivery mechanism is thereafter able to pass through the transfer passage, out of the retention zone, and into a storage location.

In a second embodiment, first and second retention assistant walls of a delivery mechanism are configured as first and second spaced apart cleats which are transversely disposed across an item carrying surface portion of an endless conveyor belt and which are displaceable by pivoting from a first position—in which a door is disposed across an item transfer passage to thereby form a boundary of the retention zone to impede movement of an item through the item transfer passage and out of the retention zone—to a second position in which the door is no longer disposed across the item transfer passage so that the item is able to pass through the transfer passage, out of the retention zone, and into a storage location.

In embodiments, a method for sorting items by delivery to target storage locations of a plurality of storage locations, an item is positioned upon the carrying surface of a delivery mechanism, the carrying surface defining a retention zone bounded by a first lateral wall, a second lateral wall, a first retention assistant (or third) wall, and a second retention assistant (or fourth) wall. At least one of the first retention assistant wall or the second retention assistant wall is/are displaceable to define a transfer passage (e.g., a channel or opening) proximate a corresponding side of the retention zone, the transfer passage being dimensioned and arranged to allow movement of an item out of the retention zone subsequent to displacement of a corresponding retention assistant wall. The delivery mechanism, which in some embodiments is configured as a delivery vehicle, moves along a path from the location where an item is received upon the carrying surface (e.g., an input station) to a location proximate the target storage location to facilitate transfer of the item through the opening obtained by displacing one of the first retention assistant wall or the second retention assistant wall.

In one or more embodiments, a method for delivering items to a storage assembly having a plurality of storage locations comprises: providing a delivery mechanism movable along a path encompassing an input station—where an item to be delivered is received—and a target storage location of the plurality of storage locations. The delivery mechanism includes (a) a support defining a carrying surface dimensioned and arranged to receive an item to be delivered and to support the item to be delivered as the delivery mechanism moves along the path, (b) a first wall extending along a first side of the carrying surface, and (c) a second wall extending along a second side of the carrying surface and opposing the first wall so that a first transfer passage (or channel) is formed proximate a first end of the support and a second transfer passage (or channel) is formed proximate a second end of the support.

In embodiments, the delivery mechanism provided during the providing step further includes a retention assistant comprising a displaceable wall dimensioned and arranged proximate a first end of the support to extend transversely relative to the first and second walls, the displaceable wall being displaceable from a first position, wherein an item disposed on the carrying surface and unrestrained is blocked from passing through the first transfer passage, into a second position wherein the unrestrained item is no longer blocked and therefore free to pass through the first transfer passage. According to such embodiments, the method further includes moving the delivery mechanism, together with a first item to be delivered, along a path to a position proximate a first target storage location; displacing the displaceable wall of the retention assistant from the first position to the second position; and transferring the first item from the delivery mechanism to the first storage location after moving the delivery mechanism.

Optionally, the retention assistant of the provided delivery mechanism is a first retention assistant having a first displaceable wall that is displaceable into the first position and the second position, and wherein the provided delivery mechanism further comprises a second retention assistant having a second displaceable wall dimensioned and arranged proximate a second end of the support to extend transversely relative to the first and second walls, the second displaceable wall being displaceable between a third position preventing an unrestrained item disposed on the carrying surface from moving into and through the second transfer passage and a fourth position permitting an item disposed on the carrying surface to pass into and through the second transfer passage, and the method further including moving the delivery mechanism with a second item to be delivered along a second path to a position proximate a second target storage location; displacing the second displaceable wall from the third position to the fourth position; and transferring the second item from the delivery mechanism to the second target storage location after the step of moving the delivery mechanism.

In a first exemplary embodiment, the displaceable wall of the first retention assistant is a first door adjacent the first end and displaceable between a closed position in which the door extends across the first transfer passage to impede transfer of items through the first transfer passage and an open position in which the first door is displaced away from the first transfer passage to permit transfer of items through the first transfer passage; wherein the first retention assistant further includes a first actuator connected with the first door to displace the door between the closed and opened positions; wherein moving the delivery mechanism with a first item to be delivered along a path to a position proximate a first target storage location includes moving the delivery mechanism toward a second actuator so that the first actuator engages the second actuator to displace the first door into the open position; and wherein transferring the first item from the delivery mechanism to the first storage location is performed after moving the delivery mechanism toward a second actuator.

Optionally, or in addition, the method of the exemplary embodiment further comprises a step of moving the delivery mechanism from the first storage location to disengage the first actuator from the second actuator. Optionally, or in addition, the method of the exemplary embodiment further comprises a step of displacing the first door into the closed position in response to the step of disengaging the first actuator from the second actuator. Optionally, or in addition, the delivery mechanism comprises a biasing element biasing the first door toward the closed position and wherein the step of displacing the first door into the closed position comprises releasing the door so that the biasing element displaces the door toward the closed position, and moving the delivery mechanism toward a second actuator comprises displacing the first actuator against the bias of the biasing element.

In any and all of the foregoing variations of the first exemplary embodiment, the delivery mechanism provided and used may be implemented as a delivery vehicle, the method in such cases further including driving the delivery vehicle toward a loading station; and driving the first actuator toward a third actuator adjacent the loading station to displace the first actuator into engagement with the third actuator to open the first door.

In a second exemplary embodiment, the support of the provided delivery mechanism includes a pair of rollers and a transfer conveyor trained around the rollers, wherein the first and second displaceable walls are cleats disposed transversely across the transfer conveyor at a spacing sufficient to accommodate receipt of an item therebetween and retention of the received item between the first and second cleats as the delivery mechanism moves toward a target storage location, the method comprising controlling movement of the transfer conveyor.

In a first variation of a method according to the second exemplary embodiment, a third cleat is included between the first and second cleats of the delivery mechanism, wherein the first and third cleat are spaced apart sufficiently to define a first retention zone for receiving a first item, and wherein the second and third cleat are spaced apart sufficiently to define a second retention zone for receiving a second item, the method including receiving a first item in the first retention zone and a second item in the second retention zone.

In a second variation of a method according the second exemplary embodiment, the method further including controlling movement of the transfer conveyor so that the first cleat is displaced into the second position; operating the feed conveyor and transfer conveyor to pass an item from the feed conveyor, through the first transfer passage, and onto the transfer conveyor of the delivery mechanism; and continuing to controlling operation of the transfer conveyor so that the first cleat is displaced into the first position.

Optionally, or in addition, a method according to the second variation further includes controlling movement of the delivery mechanism along a path to a target storage location of a plurality of storage locations, controlling the transfer conveyor of the delivery mechanism to move the first cleat into the second position, and operating the transfer initiating movement of the delivery mechanism to the first storage location after the step of moving the delivery mechanism.

A material handling system according to a further embodiment consistent with the present disclosure comprises: a plurality of storage locations; an input station; a plurality of mobile delivery mechanisms each being dimensioned and arranged to receive an item at the input station and each being movable along paths encompassing the input station and a corresponding target storage location of the plurality of storage locations; and a controller for controlling movements of the mobile delivery mechanisms along paths adjacent to the plurality of storage locations; wherein each delivery mechanism includes a transfer mechanism defining a carrying surface dimensioned and arranged to receive an item to be delivered at the station and to support the item to be delivered as the delivery mechanism moves along a respective path to a corresponding target storage location, a first lateral wall extending along a first side of the carrying surface, and a second lateral wall extending along a second side of the carrying surface and opposing the first wall so that a first transfer passage is formed proximate a first end of the support and a second transfer passage is formed proximate a second end of the support.

Delivery mechanisms of the plurality of delivery mechanisms further include a retention assistant comprising a first retention assistant wall and a second retention assistant wall, wherein the first retention assistant wall is dimensioned and arranged to extend transversely relative to the first and second lateral walls and is displaceable between a first position substantially closing the first transfer passage to thereby prevent an item on the carrying surface from moving into and through the first transfer passage and a second position permitting movement of an item to be delivered into and through the first transfer passage and into a target storage location.

In some embodiments of the material handling system, the second retention assistant wall is disposed transverse to the first and second lateral wall surfaces, is spaced apart from the first retention assistant wall, and is not manipulable out of a position impeding movement of an item through the second transfer passage and out of the retention zone. In other embodiments of the material handling division, the second retention assistant wall is displaceable from a first position substantially closing the second transfer passage—to thereby prevent an item on the carrying surface from moving into and through the second transfer passage—to a second position permitting movement of an item to be delivered into and through the second transfer passage and into a target storage location.

In any of the foregoing material handling system embodiments, each delivery mechanism may include a motor controllable to transfer a first item from the carrying surface of the transfer mechanism to a first storage location while the first retention assistant wall is in the second position. In some embodiments, each mobile delivery mechanism is a delivery vehicle, wherein the motor of each delivery vehicle is a first motor and wherein the delivery vehicle further includes a second motor operative to drive the delivery vehicle along a path from the input station to a target delivery location, and wherein the first and second lateral walls and the retention assistant are dimensioned and arranged such that an item disposed on the carrier surface of the delivery vehicle is free to move upon the carrying surface but is confined to the boundaries of the retention zone despite changes in at least one of delivery vehicle direction of travel or delivery vehicle rate of travel.

In some embodiments where each delivery mechanism is a delivery vehicle, each path traveled by a delivery vehicle of the plurality of delivery vehicles is a vertical loop path which encompasses a position proximate the input station and a position proximate a target storage location of a plurality of storage locations, wherein the input station includes an feed conveyor operatable to feed items to the delivery mechanism, wherein the second retention assistant wall is displaceable from the first position to a second position permitting movement of an item to be delivered into and through the second transfer passage, and wherein the first motor is further controllable to transfer an item out of the retention zone and into a target storage location while the second retention assistant wall is in the second position.

In embodiments, the transfer mechanism of each delivery vehicle includes an endless belt looped around a pair of rollers, wherein the retention zone is defined by an upwardly facing surface portion of the endless belt, and wherein the first motor is controllable to advance the endless belt in at least one of the first transfer direction or the second transfer direction such that a retention zone portion of the endless belt is circumscribed by surfaces of the first and second lateral walls and first and second retention assistant walls. In one such embodiment, the first and second retention assistant walls are defined by first and second elongated cleats which are separated from one another by a distance sufficient to circumscribe, with the lateral wall surfaces, the item retention zone, wherein displacement of the first retention assistant wall into the first position includes actuating the first motor to advance the endless belt such that the first and second elongated cleats are upwardly facing. In some embodiments, the first and second retention assistant walls define surfaces which extend from the carrying surface of the endless belt by a distance of from about 0.5 cm to about 3.75 cm.

In accordance with some embodiments, the first and second retention assistant walls define surfaces which are substantially orthogonal to a plane defined by a portion of the carrying surface and in other embodiments, the first and second retention assistant walls define inwardly facing surfaces which bound the retention zone and which are disposed in planes that converge relative to one another so as to form acute angles relative to the carrying surface, whereby an irregular item having a tendency to shift upon the carrying surface during positioning onto or travel of the delivery vehicle is more likely to contact a portion of a retention assistant wall located further from the carrying surface than a portion of the first or second retention assistant located closer to the carrying surface.

### BRIEF DESCRIPTION OF THE DRAWINGS

The foregoing summary and the following detailed description of the preferred embodiments of the present invention will be best understood when read in conjunction with the appended drawings, in which:

FIG. 1 is a perspective view of a material handling apparatus according to one or more embodiments consistent with the present disclosure;

FIG. 2 is a plan view of the material handling system illustrated in FIG. 1;

FIG. 3 is a side elevation view of one side of a track of the material handling system illustrated in FIG. 2;

FIG. 4 is an end view of an aisle of a variation of the material handling apparatus illustrated in FIG. 1;

FIG. 5 is a perspective view of a delivery vehicle used in the material handling apparatus illustrated in FIG. 4;

FIG. 6 is an enlarged fragmentary end view of the material handling system shown in FIG. 4 illustrating a gate of the vehicle in a closed position;

FIG. 7 is an enlarged fragmentary end view of the delivery vehicle shown in FIG. 6 illustrating the gate in a partially opened position;

FIG. 8 is an enlarged fragmentary view of the delivery vehicle shown in FIG. 6 illustrating the gate in an opened position;

FIG. 9 is an enlarged perspective view of the material handling system shown in FIG. 4, illustrating aspects of a connecting linkage of the delivery vehicle;

FIG. 10 is an enlarged perspective view of the material handling system shown in FIG. 4, illustrating the delivery vehicle at a loading station;

FIG. 11 is an enlarged fragmentary side elevational view of the material handling system shown in FIG. 10 with the vehicle gate removed illustrating features of a gate opener shown in a closed position;

FIG. 12 is an enlarged fragmentary side elevational of the system shown in FIG. 11, illustrating features of the gate opener shown in an opened position;

FIG. 13 is an enlarged fragmentary perspective view of the system shown in FIG. 12;

FIG. 14 is an enlarged fragmentary side elevational view of the system illustrated in FIG. 11;

FIG. 15 is an enlarged fragmentary side elevation view of the system illustrated in FIG. 12;

FIG. 16 is an enlarged fragmentary perspective view of the system illustrated in FIG. 13;

FIG. 17A is a fragmentary perspective view of an alternate embodiment of a delivery vehicle gate opening mechanism illustrated in the closed position;

FIG. 17B is an enlarged fragmentary perspective view of the mechanism illustrated in FIG. 17A;

FIG. 17C is an enlarged fragmentary perspective view of the mechanism illustrated in FIG. 17B with the delivery vehicle in a second position and the gate in a closed position;

FIG. 17D is an enlarged fragmentary perspective view of the mechanism illustrated in FIG. 17B with the delivery vehicle in a third position and the gate in a closed position;

FIG. 17E is an enlarged fragmentary perspective view of the mechanism illustrated in FIG. 17B with the delivery vehicle in a fourth position and the gate in a partially opened position;

FIG. 17F is an enlarged fragmentary perspective view of the mechanism illustrated in FIG. 17B with the delivery vehicle in a fifth position and the gate in an opened position;

FIG. 18A is a perspective view of a material handling system having functionality similar to that depicted in FIG. 1 but incorporating a modified input station which utilizes a feed conveyor having retention features formed or otherwise provided on the conveyor surface and cooperable with similar retention features formed or otherwise provided on the carrier surface of a movable delivery mechanism, according to one or more alternate embodiments consistent with the present disclosure;

FIG. 18B is a side elevation view of the material handling system of FIG. 18A, depicting relative orientations of the feed conveyor surface and the carrying surface of a delivery vehicle implementation of a movable delivery mechanism according to one or more embodiments consistent with the present disclosure;

FIG. 18C is a cross-sectional side view taken across a vertical plane to depict the arrangement of respective storage locations correspondingly disposed at the distal end of an associated discharge chute and to further depict the relative position of a delivery vehicle during and subsequent to the transfer of item 11 onto one of the discharge chutes.

FIG. 18D is a partial cross-sectional side view taken across the same vertical plane as shown in FIG. 18C but enlarged to show a gap beneath the carrier surface dimensioned and arranged to permit movement of a retention assistant wall from its first position shown in FIGS. 18A to 18C and 18E to a second position which, in the embodiment of FIGS. 18A to 18E extends downwardly relative to and beneath the carrier surface;

FIG. 18E is a partial perspective view of the material handling system of claims 18A to 18D following restoration of two retention assistant walls to their respective first positions defining a circumscribed retention zone Z1;

FIG. 19A is a perspective view of an exemplary embodiment of a delivery vehicle for use as a delivery mechanism in a material handling system consistent with FIGS. 18A to 18E, the delivery vehicle having an endless belt and first and second cleats which, together with lateral side walls of the delivery vehicle, define a circumscribed item retention zone when the retention assistant walls are in their respective first positions;

FIG. 19B is a perspective view of an alternative exemplary embodiment of a delivery vehicle for use as a delivery mechanism in a material handling system consistent with FIGS. 18A to 18E, the delivery vehicle having an endless belt and first, second, and third retention assistant walls in the form of cleats which, together with lateral side walls of the delivery vehicle, define first and second circumscribed item retention zones when the retention assistant walls are in their respective first positions;

FIG. 19C is a side elevation view depicting a delivery vehicle according the embodiment of FIG. 19A or FIG. 19B, in which a retention assistant wall in a position which closes the transfer passage through which an item to be delivered could otherwise be transferred to a target storage location; and

FIG. 19D is a perspective view of a delivery vehicle in which a retention assistant wall has been displaced from the first position shown in FIGS. 18A, 19A and/or 19C, to the second position shown in 18D whereby an item as item 11 is no longer impeded from passing through a transfer passage formed by the lateral walls and carrying surface of the delivery vehicle;

FIG. 20 is a perspective view of an alternate feed conveyor and an alternate delivery vehicle;

FIG. 21 is a diagrammatic plan view of the delivery vehicle and feed conveyor illustrated in FIG. 20.

FIG. 22 is a perspective view of an alternate embodiment of the delivery vehicle illustrated in FIG. 19; and

FIG. 23 is a perspective view of an alternate embodiment of the delivery vehicle illustrated in FIG. 19.

### DETAILED DESCRIPTION OF THE INVENTION

As the overall throughput of a material handling system that uses such mobile delivery mechanisms as delivery vehicles is limited, in substantial part, by the rate at which an object can be transferred to the delivery mechanism and the rate at which the delivery mechanism accelerates, moves, and decelerates as it traverses a delivery path to a target storage location, the inventors herein have noted that undesirable tradeoffs have been necessary to meet the objective of accommodating a wide variety in the physical characteristics (especially the shape) of the items to be processed by the system.

For example, in the sortation of items to form groups of items fulfilling customer orders, items sorted to a first target storage location to fulfill a first order requirement might include only items conforming to dimensional restrictions (height, weight, and length) while in addition having a unform polygonal cross section along all three orthogonal axes. Since items having such a physical profile are inherently stable during motion in a direction of transfer as they are carried by an underlying surface, they are neither likely to roll or shift during the initial transfer of the item to the carrying surface of the delivery mechanism (e.g. as they are transferred from a surface of an input conveyor) nor are they likely to do so as the delivery mechanism traverses the delivery path to the first target storage location.

Were items having inherently stable shapes to be the only ones handled by a material handling system fulfillment of orders, the empirical determination of such parameters as the rate of item transfer from an input (feed) conveyor, and the speed and respective rates of delivery mechanism acceleration and deceleration as the delivery mechanism moves the item along the delivery path are relatively straightforward. That is, once the upper limits have been established for such parameters for each anticipated delivery path, operations of the input conveyor and movements of the delivery vehicle need only be maintained below those limits to ensure that dimensionally conforming and inherently stable items—regardless of how they are oriented relative the carrying surface—are reliably and repeatably received, transported and delivered by the delivery mechanism such that the item arrives at the intended target storage location.

Heretofore, however, efforts to apply those same parameter limits to items which are not inherently stable such, for example, as those items having a circular cross-sectional profile (e.g., those that are cylindrically or spherically shaped) or possibly even those having substantial local variations in density, have met with unpredictable or predictably poor results. Spherical objects, for example, are unstable in all directions and have been deemed wholly unsuited to seriatim transport by mobile delivery mechanism unless packaged in a container which itself does have an inherently stable shape.

When a cylindrically shaped object is not oriented such that its axis of rotation is precisely parallel to the direction in which it is being conveyed, whether by input station conveyor or by delivery mechanism, it is prone to shifting and uncontrolled rolling movements. At times, such movements can and do result in items rolling off the delivery mechanism either during the process of transfer or during periods of delivery mechanism movement. In view of these observations, the inventors of the inventions described herein have determined that impact upon overall system throughput and performance is minimized by systems and methods which enhance the retention of respective items as transported by corresponding mobile delivery mechanisms, and optionally, as they are supplied to the mobile delivery mechanisms (e.g., by an input station feed conveyor).

In embodiments, irregularly shaped items such, for example, as those having a cross sectional profile characterized by arcuate surface portions (e.g., cylindrically or spherically shaped items) are free—during movement of the delivery mechanisms along an item delivery path—to move upon a carrying surface of the delivery mechanism, but such movement is constrained to the boundaries of a defeatable retention zone despite changes in the direction and/or velocity of the delivery mechanism. Avoiding restriction of item movement beyond confinement to the defeatable retention zone has the advantage of minimizing the delay between arrival of an item into the retention zone of a delivery mechanism and progress of the delivery mechanism toward an intended target storage destination. Likewise, once the delivery mechanism arrives at the target storage destination, transfer can commence immediately by actuation of a transfer mechanism as, for example, an endless conveyor belt.

When intact, the defeatable retention zone is bounded by first and second spaced apart lateral side walls of the delivery mechanism and first and second spaced apart retention assistant walls. The retention zone is defeatable in the sense that at least one of the retention assistant walls is displaceable such that it/they can be moved from a first position which extends transversely relative to the lateral side walls to close off a corresponding transfer passage through which an item could otherwise escape the retention zone and a second position which temporarily removes an applicable retention assistant wall as a boundary of the retention zone.

In a first embodiment, each of one or more retention assistant walls of a delivery mechanism are configured as one or more pivotably movable door(s) which are displaceable, relative to a carrying surface of the delivery mechanism, by pivoting from a first position—in which a door is disposed across an item transfer passage to thereby form a boundary of the retention zone to impede movement of an item through the item transfer passage and out of the retention zone—to a second position in which the door is no longer disposed across the item transfer passage and an item being carried by the delivery mechanism is thereafter able to pass through the transfer passage, out of the retention zone, and into a storage location.

In a second embodiment, first and second retention assistant walls of a delivery mechanism are configured as first and second spaced apart cleats which are transversely disposed across an item carrying surface portion of an endless conveyor belt and which are displaceable by pivoting from a first position—in which a door is disposed across an item transfer passage to thereby form a boundary of the retention zone to impede movement of an item through the item transfer passage and out of the retention zone—to a second position in which the door is no longer disposed across the item transfer passage so that the item is able to pass through the transfer passage, out of the retention zone, and into a storage location.

Some portions of the detailed description which follow are presented in terms of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference will now be made in detail to exemplary embodiments of the present invention, examples of which are illustrated in the accompanying drawings. Wherever possible, the same reference numbers will be used throughout the drawings to refer to the same or like parts.

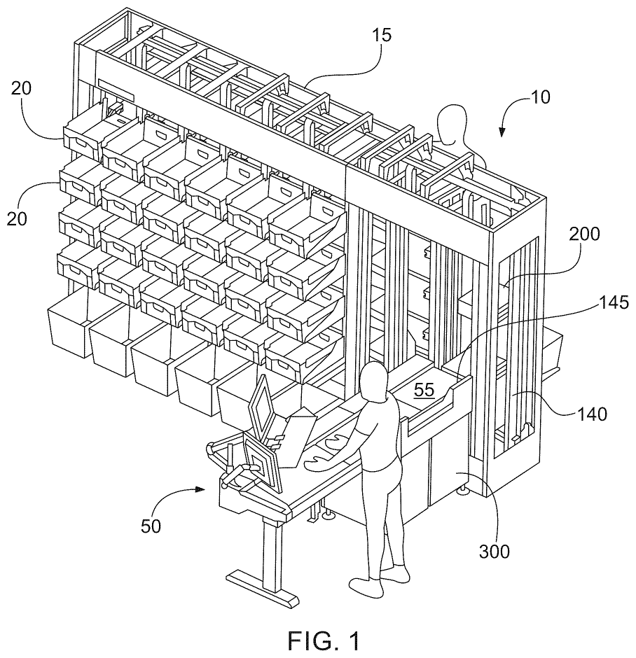

Referring now to FIGS. 1-4, a material handling system is designated generally 10. The system includes a sorting system 15 that sorts items into a plurality of sort locations, such as sort bins 20. The sort system 15 may include a plurality of bins arranged in a series of rows or columns forming a first group of bins 30. A second group of bins 35 may be spaced apart from the first group of bins so that an aisle 100 is formed between the groups of bins. A plurality of delivery vehicles 200 may travel within the aisle 100 to delivery items to the different bins 20.

The delivery vehicles may be configured so that a plurality of delivery vehicles 200 operate independently at the same time to deliver a plurality of items. Additionally, the delivery vehicles 200 may travel within the aisle 100 to deliver items to the sort bins 30, 35. Optionally, the delivery vehicles 200 may move from a loading station 145 to one of the delivery locations and then return to the loading station so that another item can be delivered to one of the bins.

The system 10 may include a central controller 300 to control various aspects of the system and to provide control signals to various components of the system. The central controller may include one or more microprocessors. Additionally, the central controller 300 may be connected with a warehouse management system (WMS) that provides signals to the system 10 regarding the groupings into which the items are to be sorted. For instance, the WMS may indicate which items are to be grouped together to form an order. In this way, the WMS may provide information to the central controller about the grouping of items and the central controller 300 controls the operation of various items, such as delivery vehicles, gates, scanners etc to sort the items in accordance with the information received from the WMS.

Each delivery vehicle may follow a different path from the loading station to one of the sort locations. The track 105 may include a plurality of vertical and horizontal track segments that guide the delivery vehicles as the delivery vehicles move from the loading station to the sort bin and then back to the loading station.

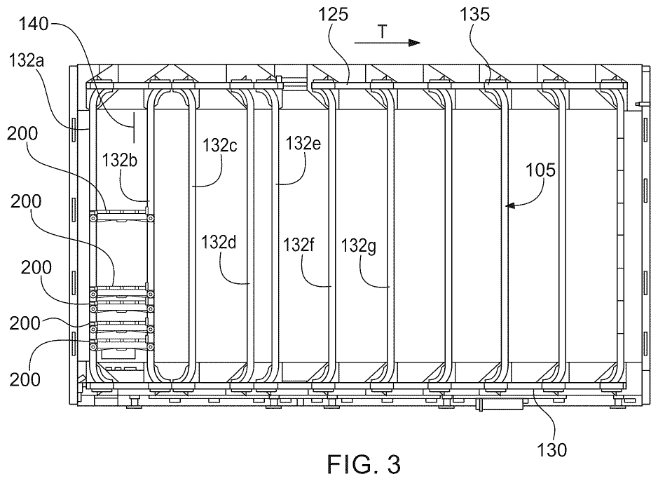

The vertical and horizontal track segments may form a path in the shape of a vertical loop in the aisle. For instance, referring to FIGS. 1 & 3, the track 105 may include a front track 110 and a rear track 120. In FIG. 3, the front track is illustrated and it should be understood that the rear track is substantially similar to the front track so that the rear track mirrors the front track.

The front track may have an upper track segment 125 and a parallel lower track segment 130. A plurality of vertical tracks 132 may connect the upper track with the lower track. As shown in FIG. 3, the vertical tracks 132 may separate the track into a series of columns along which the vehicles may move up or down to one of the sort bins. Alternatively, as described previously, the track may include a plurality of horizontal tracks that separates the track into a series of rows along which the vehicles may move along to one of the sort bins 20.

In the track illustrated in FIG. 3, the track includes a plurality of vertical columns. Each column is defined by a pair of vertical tracks. The delivery vehicle may move vertically upwardly or downwardly within the column. For instance, vertical tracks 132a and 132b define a first column to guide the delivery vehicles. This first column may be a loading column 140 having a loading station 145 at which each vehicle receives an item to be delivered to one of the sort bins 20.

The track 105 may include columns that share vertical track and columns that have separate vertical tracks. For instance, as shown in FIG. 3, a second column is defined by vertical tracks 132c and 132d and delivery vehicles can move vertically upwardly or downwardly within this second column. The second column does not share any vertical tracks with the first column. In contrast, a third column is formed by vertical tracks 132e and 132f and a fourth column is formed by vertical tracks 132f and 132g. In this way, the third and fourth column share a vertical track.

A plurality of gates 135 may be positioned along the track to guide the delivery vehicles along the track. For instance, a delivery vehicle may move horizontally along the upper track 125 until it reaches the column having the sort bin 20 to which the delivery vehicle is to deliver an item. Once the delivery vehicle reaches the appropriate column, the gates fire, directing the delivery vehicle to move down the column from the upper rail. The delivery vehicle may have an actuator for selectively actuating the gates. Alternatively, each gate may have an actuator for automatically actuating the gate from a first position in which the delivery vehicle is directed in a horizontal direction to a second position in which the delivery vehicle is directed from a horizontal direction to a vertical direction. For instance, each gate may be controlled by a solenoid or other element configured to move a gate in response to signals from the controller.

The flow of delivery vehicles 200 along the track may move along any of a variety of paths. According to one embodiment, the vehicles move along a path forming a vertical loop and the vehicles generally move along the vertical loop in a forward direction.

For instance, from the perspective of FIG. 3, the delivery vehicles follow a vertical loop in a clockwise direction as shown by arrow T. Specifically, from the loading station 145 the delivery vehicle moves upwardly in the first column 140 until the delivery vehicle reaches the upper track 125. At the upper track the vehicle transitions from vertical movement to horizontal movement. The delivery vehicle moves along the upper track 125 in the direction of T until the vehicle reaches the column having the sort bin to which the delivery vehicle is to deliver an item. For instance, if the destination bin 20 is in the fourth column, the delivery vehicle moves along the upper rail until reaching vertical tracks 132f and 132g. The gates 135 are actuated so that the delivery vehicle is directed downwardly down the fourth column. The delivery vehicle continues moving downwardly until reaching the destination bin 20.

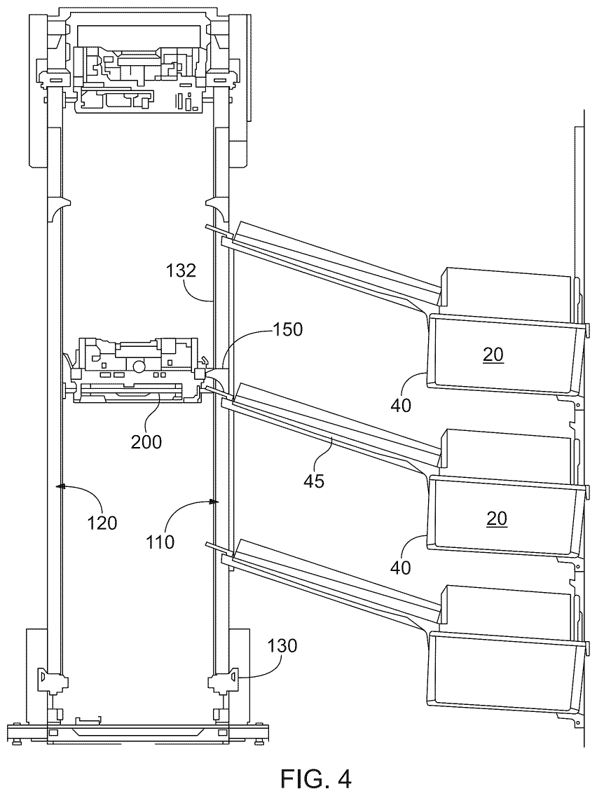

At the destination bin, the delivery vehicle discharges the item into the destination bin. The vehicle may discharge the item directly into the bin as in the embodiments illustrated in FIGS. 1-3. Alternatively, as illustrated in FIG. 4, each bin may have an associated chute 45 angled downwardly from the aisle 100 to the bin 20. The vehicle may discharge the item onto the chute 45 so that the item slides down the chute into the bin 20.

The delivery vehicle then continues down the column until reaching the lower track 130. Upon reaching the lower track the delivery vehicle transitions from vertical travel to horizontal travel. The delivery vehicle then travels to the left (from the perspective of FIG. 3) to return to the loading column 140.

As described above, the delivery vehicle travels along a path that forms a vertical loop in the aisle. Specifically, the delivery vehicle travels in a clockwise direction from the loading zone to the upper rail to one of the columns and down to the lower track, which it follows back to the loading column. Each vehicle follows along a path forming a vertical loop but the path for each vehicle may differ depending on which sort bin 20 the delivery vehicle is directed.

The delivery vehicles may be controlled to continue to flow in a common direction, such as a clockwise direction as discussed above. However, it should be understood that although the vehicles may generally flow in a common direction (such as clockwise) there may be instances in which one of the vehicles may move in the opposite direction as the vehicle moves around the vertical loop. For instance, after moving downwardly along the fourth column, it may be desirable to move the vehicle upwardly within the fourth column before driving the vehicle downwardly to the lower track 130. In such an instance, the general flow of the delivery vehicle is the same: a clockwise path following a vertical loop the moves forwardly from the loading station 145 to one of the sort bins and then returns to the loading station along a separate return path.

The track 105 is generally configured to cooperate with the delivery vehicles. Specifically, the delivery vehicles 200 may include drive elements having teeth. In such an embodiment, the track may include teeth that mesh with the teeth of the vehicle drive elements. Similarly, the delivery vehicles may include drive elements that frictionally engage the track, such as drive wheels. In such an embodiment, the track need not have teeth. Accordingly, it should be understood that the delivery vehicles may include a variety of known drive mechanisms. The track 105 is configured to cooperate with the drive mechanism of the delivery vehicle to guide the delivery vehicles within the aisle.

As described above, the configuration of the track may vary depending on the configuration of the delivery vehicle. An exemplary track may be similar to the track in U.S. Pat. No. 7,861,844. The entire disclosure of U.S. Pat. No. 7,861,844 is hereby incorporated herein by reference.

The system may be configured so that items are directly loaded onto the delivery vehicles at the loading station. For instance, an operator may place an item directly onto the vehicle at the loading station 145. Additionally, a scanner or other indicia acquisition system (not shown) for acquiring the UPC code or other item identifying indicia, or an image acquisition system (not shown) configurable to report an image of items for their identification and association with orders to be fulfilled by system 10 may be provided for scanning an item before the item is loaded onto the delivery vehicle. It should be understood that the term operator may include a human operator or a mechanical operator, such as a robotic arm or similar element.

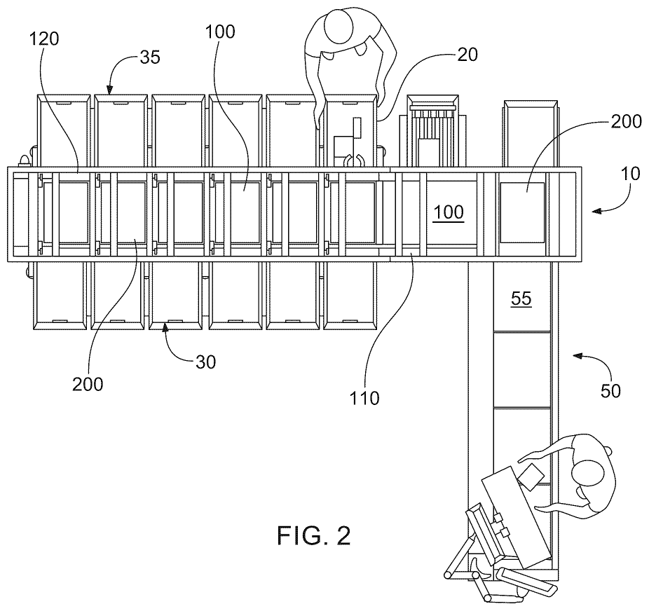

Alternatively, the system may include an input station 50 for loading items onto the delivery vehicles as shown in FIGS. 1 and 2. The input station may include a feed conveyor 55 (FIGS. 1 and 2) for conveying items toward the loading station 145. The feed conveyor 55 may include a first end forming a drop zone where items may be dropped or placed onto the feed conveyor. The second end of the feed conveyor may be adjacent the loading station so that the conveyor conveys the items from the drop zone to the loading station. At the loading station, the items are loaded on the delivery vehicles.

Various factors may be detected to evaluate how an item is to be processed. For instance, an item typically needs to be identified so that the system can determine the location or bin to which the item is to be delivered. This is normally done by determining the unique product code for the item. The system may include a scanning element for scanning a product identification marking on the product. By way of example, the items may be marked with one or more of a variety of markings, including, but not limited to, machine-readable optical labels, such as bar codes (e.g., QR or UPC codes), printed alphanumeric characters or a unique graphic identifier. The scanning station may include a scanner or reader for reading such a marking. For instance, a bar code reader, optical reader or RFID reader may be provided to scan the item to read the identification marking.

Accordingly, the input station 50 may include a scanner for scanning the items before they are placed onto the conveyor. Alternatively, the input station may include a scanner that scans the items as the items move along the feed conveyor.

Once the product identification marking is determined (either manually or automatically), the system retrieves information regarding the product and then controls the further processing of the item based on the information stored in the central database.

At the input station 50, items are inducted into the system by serially loading items onto the vehicles 200. In one embodiment, each item is manually scanned at the induction station to detect one or more features of the item. Those features are used to ascertain the identification of the item. Once the item is identified, various characteristics of the item may be retrieved from a central database and the item may be subsequently processed based on the known characteristics of the item. For instance, the input station 50 may include a scanning station that scans for a product code, such as a bar code. Once the product code is determined, the system retrieves information regarding the product from a central database. This information is then used to control the further processing of the item.

### Delivery Vehicles

As noted above, the sorting system may include a plurality of independently operable delivery vehicles 200. Each delivery vehicle is configured to deliver one or more items to one of the sort bins. The following description provides the details of an exemplary delivery vehicle. However, it should be understood that the sorting system need not be limited to one that utilizes a plurality of delivery vehicles. Additionally, the configuration of the delivery vehicles may vary depending on a variety of factors. Accordingly, it should be understood that the following discussion provides the details of an exemplary vehicle, and the sorting system is not limited to use with a delivery vehicle having the details described below.

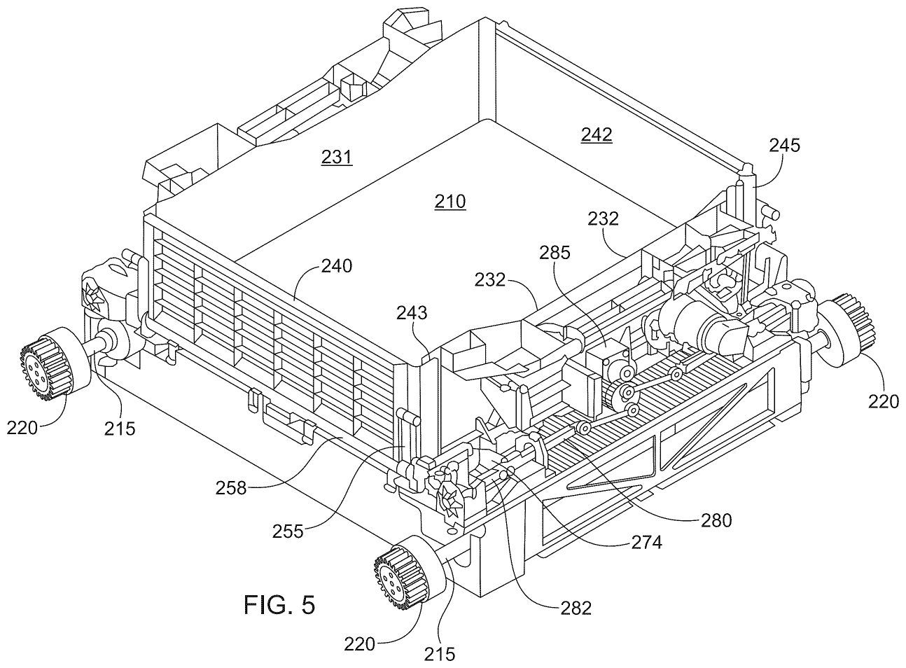

Referring to FIG. 5 a semi-autonomous vehicle 200 is illustrated. The delivery vehicle has an onboard drive system, including an onboard power supply. The delivery vehicle 200 includes a mechanism for loading and unloading items for delivery. An embodiment of a vehicle that may operate with the sorting system 15 is illustrated and described in U.S. Pat. No. 7,861,844.

The vehicle 200 may incorporate any of a variety of mechanisms for loading an item onto the vehicle and discharging the item from the vehicle into one of the bins. Additionally, the loading/unloading mechanism 210 may be specifically tailored for a particular application. In the present instance, the loading/unloading mechanism 210 is one or more conveyor belts that extend along the top surface of the vehicle. The conveyor belts are reversible. Driving the belts in a first direction displaces the item toward the rearward end of the vehicle; driving the belt in a second direction displaces the item toward the forward end of the vehicle.

A conveyor motor mounted on the underside of the vehicle drives the conveyor belts. Specifically, the conveyor belts are entrained around a forward roller at the forward edge of the vehicle, and a rearward roller at the rearward edge of the vehicle. The conveyor motor is connected with the forward roller to drive the forward roller, thereby operating the conveyor belts.

The vehicle includes four wheels that are used to transport the vehicle along the track 105. The wheels are mounted onto two parallel spaced apart axles 215, so that two or the wheels 220 are disposed along the forward edge of the vehicle and two of the wheels are disposed along the rearward edge of the vehicle.

Each wheel 220 may comprise an outer gear that cooperates with the drive surface of the track. The outer gear is fixed relative to the axle onto which it is mounted. In this way, rotating the axle operates to rotate the gear. Accordingly, when the vehicle is moving vertically the gears cooperate with the drive surface of the track to drive the vehicle along the track.

The vehicle includes an onboard motor for driving the wheels. More specifically, the drive motor is operatively connected with the axles to rotate the axles, which in turn rotates the gears of the wheels.

In the embodiment illustrated in FIG. 5, a wall 231 at the leading edge of the vehicle extends the width of the vehicle. The wall operates as a stop or constraint, limiting items from falling off or being discharges from the leading edge of the vehicle. Similarly, the vehicle 200 may include a trailing wall 232 that may extend across the width of the vehicle. The trailing wall 232 may operate as a stop or constraint, limiting items from falling off or being discharged from the trailing edge of the vehicle.

As the vehicle travels along the track, an item on top of the vehicle may tend to fall off the vehicle, especially as the vehicle accelerates and decelerates. Therefore, the vehicle may include a retainer to retain the element on the vehicle during delivery.

A variety of retainers can be used to improve retention of items on the vehicles. One exemplary retainer is illustrated in FIGS. 5-8. In the illustrated embodiment, the retainer comprises one or more end walls 240, 242 that span the gap between the side walls 231, 232. The end walls 240, 242 combine with the side walls 231, 232 to form an enclosure or perimeter that surrounds the upper surface of the vehicle. In this way, the end walls 240, 242 and side walls 231, 232 provide an enclosure to retain items on top of the vehicle.

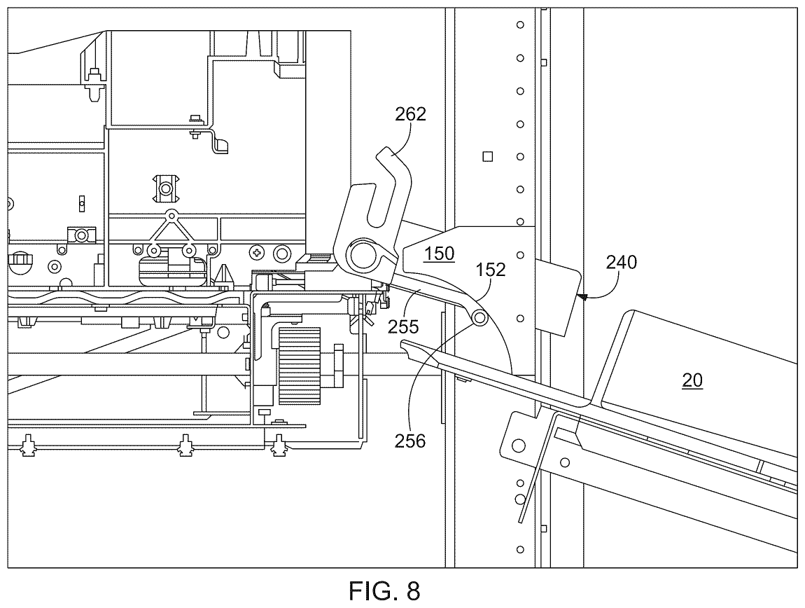

The end walls 240, 242 are displaceable to provide transfer passages at the front and rear of the vehicle to allow items to be displaced onto the vehicle and to allow items to be discharged from the vehicle. For instance, each wall may be displaceable between an upright position and a lowered position. In FIG. 5 the end walls 240, 242 are illustrated in the upright position in which the end walls are substantially vertical to form stops that impede items from moving off of the vehicle. In FIG. 8 the end wall 240 is illustrated in a lowered position in which the end wall is generally horizontal so that an item can be discharged from the vehicle.

The vehicle 200 may include a drive mechanism for driving the end walls between the upright and the lowered positions. For instance, the vehicle may include a motor, solenoid or similar actuator for driving the end walls up and down. However, in the present instance, the vehicle cooperates with an opening mechanism 150 mounted along the track 105 to lower the end walls from the upright to the lowered position. By raising and lowering the end walls, the displaceable end walls operate as gates.

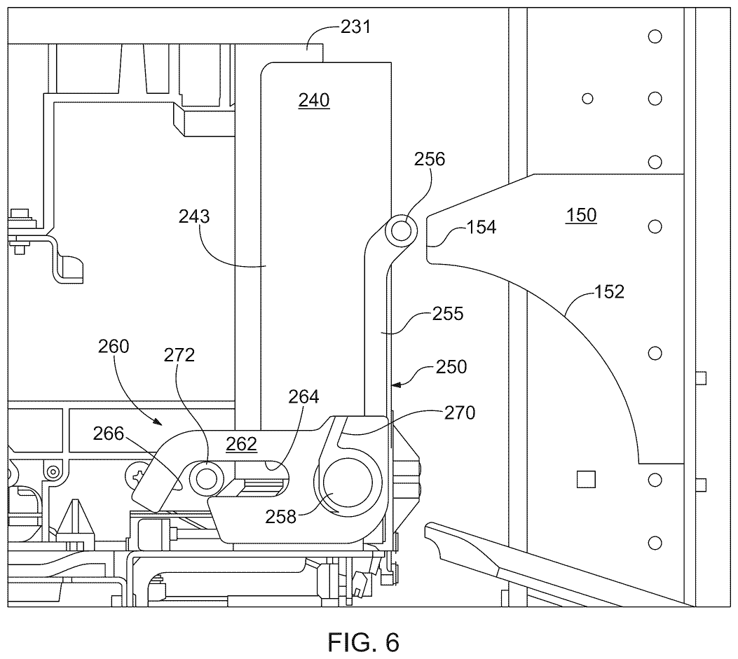

Referring to FIGS. 6-8, the gates 240, 242 are connected with a gate actuator 250 that cooperates with the gate opener 150 to lower the gates. In FIG. 6, the gate actuator 250 is disposed in a first position that corresponds with the gate 240 in the upright position. In the first position, the vehicle 200 is displaceable vertically within the aisle 100 without engaging the gate opener 150. In other words, in the first position, the gate actuator 250 may be spaced apart laterally from the gate opener 150 so that a gap is formed between the gate actuator 250 and the gate opener 150.

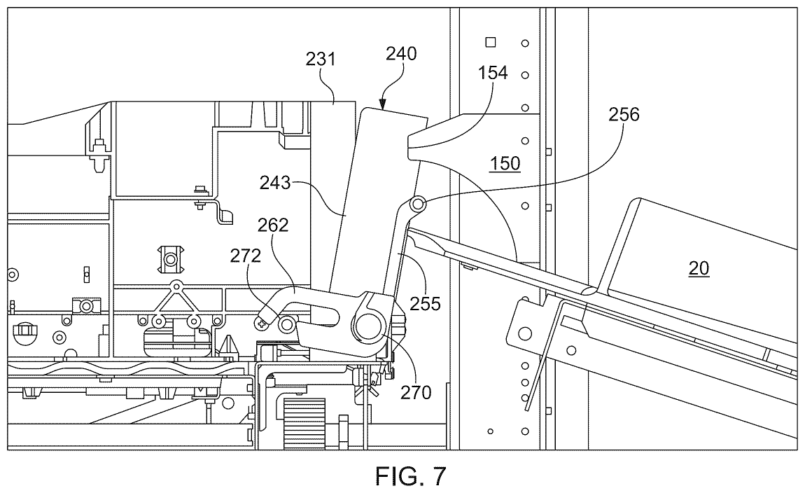

In FIG. 7, the gate actuator 250 is partially actuated in which the gate actuator extends toward the gate opener 150 so that displacing the vehicle vertically displaces the gate actuator into engagement with the gate opener. With the gate actuator 250 in the second position, the gate 240 is partially opened, but is still generally vertical to retain items on the vehicle. In other words, in the partially opened position, there is no lateral gap between the gate actuator 250 and the gate opener 150.

In FIG. 8, the gate actuator 250 is in engagement with the guide surface 152 of the gate opener 150 so that the gate actuator is in the actuated position to lower the gate 240. In the lowered position, the gate 240 is generally horizontal or angled downwardly away from the surface of the vehicle. In the lowered position, the transfer mechanism 210 is operable to discharge an item from the vehicle into the adjacent bin 20.

Referring again to FIG. 6, the gate actuator 250 includes a follower 256 formed at the end of the arm 255. The follower may be any of a variety of following elements, such as a rounded surface at the end of the arm. In the present instance, the follower 256 comprises a rotatable element, such as a bearing element rotatably mounted to the arm. The follower 256 comprises the surface that engages the gate opener 150 to open the gate 240.

In the upright or closed position shown in FIG. 6, the follower is positioned so that a gap is formed between the follower and the inner edge 154 of the gate opener. In this way, the vehicle can move vertically relative to the gate opener 150 without engaging the gate opener.

In the second position shown in FIG. 7, in which the follower is partially actuated, the follower 256 is positioned so that the follower horizontally overlaps the gate opener. Specifically, the follower projects horizontally beyond the inward edge 154 of the gate opener. However, there may be a vertically gap between the follower 256 and the opener 150. When the follower is displaced into the second position, moving the vehicle upwardly relative to the opener displaces the follower into engagement with the opener. Once the follower 256 engages the opener 150, the guide surface 152 of the opener guides the follower if the vehicle is displaced vertically relative to the opener. Specifically, as the vehicle moves upwardly, the follower 256 follows the guide surface 152 thereby displacing the arm 255 downwardly, which lowers the gate 240 as shown in FIG. 8.

The vehicle includes a drive element for displacing the arm 255 between the upright position and the engagement position in which the arm projects outwardly sufficiently to engage the gate opener 150. The drive element may be any of a variety of items, such as a solenoid, motor, etc. In the present instance, the vehicle includes a motor 285 for driving the arm and a connecting linkage 260 for connecting the motor with the arm 255 (see FIGS. 5-6).

Referring to FIGS. 5, 6 and 9, the connecting linkage 260 includes a drive linkage 280 that forms a slider crank to convert the rotational motion of the motor 285 into linear motion to displace a slider bar 282. Driving the motor in a first direction extends the slider bar 282 outwardly toward the bins. In the extended position the slider bar may be configured to engage an actuator on gates at intersections along the track. Driving the motor in a second direction retracts the slider bar 282 inwardly toward the motor 285.

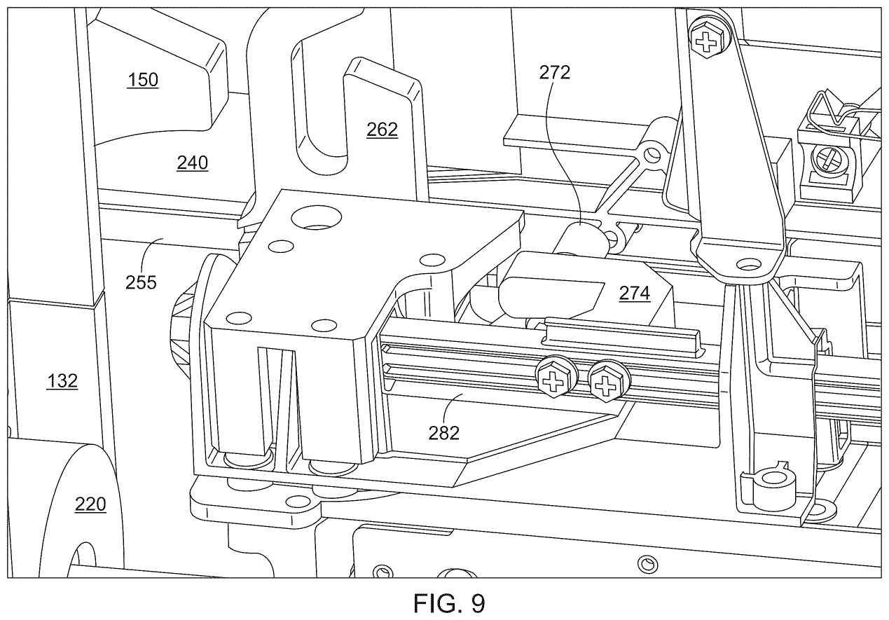

The arm 255 is releasably connected with the motor so that driving the motor in the first direction does not actuate the arm, but when the motor is driven in the second direction the arm is driven into the second position. For instance, as shown in FIG. 6, the actuating arm 255 is connected with a hub 260. The hub 260 is in operable engagement with a drive pin 272 that is rigidly connected with the slider bar 282 by a connecting arm 274 (shown in FIGS. 5 and 9). The hub includes a slot 264 configured to allow the pin to freely slide within the slot. The rearward end of the slot forms an angled actuation surface 266.

Referring to FIG. 6, the actuator arm 255 is shown in the vertical position in which the gate 240 is closed. In this position, the drive pin 272 is positioned toward the rearward end of the slot 264 in the hub 262. Driving the motor 285 in a first direction drives the slider bar 282 outwardly so that the end of the slider bar projects outwardly from the vehicle. In this extended position, the end of the slider bar forms an actuator operable to actuate the track gates 135 to divert the vehicle's direction of travel. Driving the slider bar 282 outwardly also displaces drive pin 272 outwardly (from left to right toward the bin 20 from the perspective of FIG. 6). When the drive pin moves outwardly, the drive pin moves within the slot 264 without displacing the hub 262. In this way, driving the motor 285 in a first direction does not actuate the vehicle gates 240, 242.

Referring to FIG. 7, driving the motor 285 in a second direction drives the drive pin 272 in a second direction so that the drive pin contacts the angled wall forming an actuation surface 266 adjacent the rearward end of the slot 264 in the hub 262. Continuing to drive the drive pin in the rearward direction drives the hub 262 and the attached arm 255 around an axis of rotation formed by shaft 258. In this way, the drive pin 272 is operable to displace the arm 255 into the second position in which the follower 256 is positioned to engage the gate opening mechanism 150 adjacent the track.

After the arm 255 is displaced into the extended position pictured in FIG. 7, the vehicle 200 is displaced relative to the track so that the follower 256 is displaced into engagement with the gate opener 150. Specifically, the vehicle 200 is displaced upwardly relative to the gate opener. As the vehicle moves upwardly, the follower 256 engages a guide surface 152 of the gate opener. The guide surface 152 guides displacement of the follower 256 as the vehicle moves upwardly causing the arm 255 to pivot into the opened position as shown in FIG. 8. The hub 262 may include a slot or opening that intersects the slot 264 so that the hub may disengage the drive pin 272 as the arm 255 pivots into the open position. The vehicle gate 240 is attached to the arm 255 so that pivoting the arm into the opened position also pivots the vehicle gate into the opened position as shown in FIG. 8.

As discussed above, the vehicle gate 240 is displaced from the closed position into the opened position. In the closed position, the gate 240 is substantially vertical to provides a stop impeding items from being displaced off the vehicle surface (the horizontal surface of conveyor 210). In the open position, the vehicle gate is generally horizontal so that items may be displaced off the vehicle. Additionally, as shown in FIG. 8, in the open position the vehicle gate may angle downwardly forming an angle relative to the horizon to form a ramp. The ramp directs items from the vehicle downwardly toward the bin 20 or toward the chute 45.

After the vehicle gate 240 is displaced into the open position, the vehicle 200 drives the transfer mechanism 210 to discharge an item into the bin 20. After the item is discharged into the bin 20, the vehicle moves away from the bin to return to the loading station to receive the next item to be delivered. In the present instance, the vehicle moves downwardly along the vertical track 132. As the vehicle moves downwardly, the follower 256 moves out of engagement with the gate opener 150.

The vehicle 200 may include a connection with the motor 285 that drives the motor from the opened position in FIG. 8 to the closed position illustrated in FIG. 6. However, in the present instance, the vehicle 200 includes one or more biasing elements biasing the vehicle gates 240, 242 into the close position. For instance, in the present instance, one or more torsion spring 270 bias the vehicle gate toward the closed position. In this way, when the follower 256 is displaced away from the gate opener 150, the biasing elements displace the vehicle gates 240, 242 into the closed position.

The vehicle 200 may be powered by an external power supply, such as a contact along the rail that provides the electric power needed to drive the vehicle. However, in the present instance, the vehicle includes an onboard power source that provides the requisite power for both the drive motor and the conveyor motor. Additionally, in the present instance, the power supply is rechargeable. Although the power supply may include a power source, such as a rechargeable battery, in the present instance, the power supply is made up of one or more ultracapacitors.

The vehicle further include a controller including, for example, a central processor unit (CPU) (not shown) for controlling the operation of the vehicle in response to signals received from the central controller 300. Additionally, the vehicle includes a wireless transceiver (not shown) so that the vehicle can continuously communicate with the CPU as it travels along the track. Alternatively, in some applications, it may be desirable to incorporate a plurality of sensors or indicators positioned along the track. The vehicle may include a reader for sensing the sensor signals and/or the indicators, as well as a memory (not shown) containing instructions executable by the CPU to control the operation of the vehicle in response to the sensors or indicators.

If the system 10 includes a number of delivery vehicles 200, the positioning of the vehicles is controlled to ensure that the different vehicles do not crash into each other. In one embodiment, the central controller 300 that tracks the position of each vehicle 200 and provides control signals to each vehicle to control the progress of the vehicles along the track. The central controller 300 may also control operation of the various elements along the track, such as gates 135 that re-direct the vehicles from a horizontal direction of travel to a vertical direction of travel or vice versa.

As discussed above, the system may include an actuator positioned along the vehicle path to open the vehicle gate to facilitate delivery of items. The system may include a similar actuator positioned along the vehicle path to open the vehicle gate to facilitate loading an item onto the vehicle. The actuator for opening the vehicle gate for loading items may be positioned adjacent the loading station 145 and may be configured similar to the gate opener 150 described above. Optionally, the actuator to open the vehicle gate for loading items may be configured differently than the actuators 150 adjacent the bins.

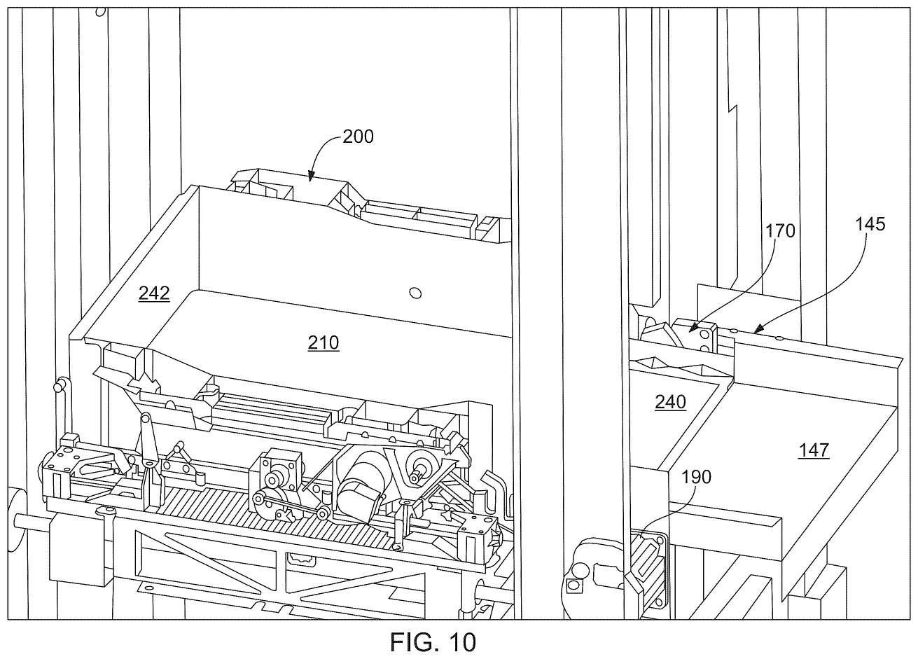

Referring to FIGS. 10-16, an alternate actuator for opening the vehicle gates at the loading station 145 is illustrated. The loading station 145 in FIGS. 10-16 is illustrated without the conveyor 55 (FIG. 2). Instead, items are loaded onto the vehicles 200 directly or from a support surface 147 adjacent the loading column. The items may be placed directly onto the vehicle 200 while the vehicle gates are closed, however, in the present instance, one of the vehicle gates is opened at the loading station 145 to facilitate loading an item onto the vehicle.

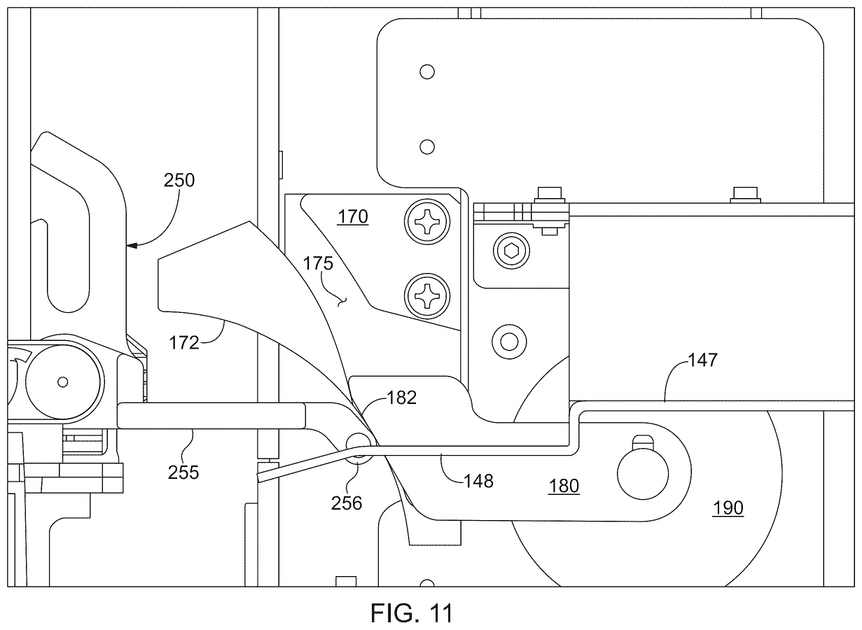

Referring to FIGS. 11-13, a gate opener 170 at the loading station 145 is illustrated. In FIGS. 11-3, the vehicle 200 is illustrated with the vehicle gate 240 removed to show features of the gate opener 170 and the gate actuator 250. The gate opener 170 includes two separate guide surfaces 172, 175. The first guide surface 172 is a curved surface configured similarly to guide surface 152 of the gate opener 150 described above. Accordingly, as the vehicle moves toward the loading station, the arm 255 is moved outwardly to engage guide surface 172, similarly to how the arm 255 is moved outwardly to engage gate actuator 150 discussed above in connection with FIGS. 7 and 8. The second guide surface 175 allows the vehicle gate 240 to close without having to move the vehicle downwardly.

The gate opener 170 includes a guide arm for guiding the following arm 255 between the first guide surface 172 and the second guide surface. The guide arm is configured so that in the first position, the following arm 255 follows the first guide surface 172 and in a second position, the following arm follows the second guide surface 175. As shown in FIG. 10, in the first position, the guide arm 180 has an exterior surface 182 that aligns with guide surface 172 to provide a continuation of the gate opener guide surface. In this way, the follower 256 follows along guide surface 172 of the gate opener 170 and onto the guide surface 182 of the pivoting guide 180.

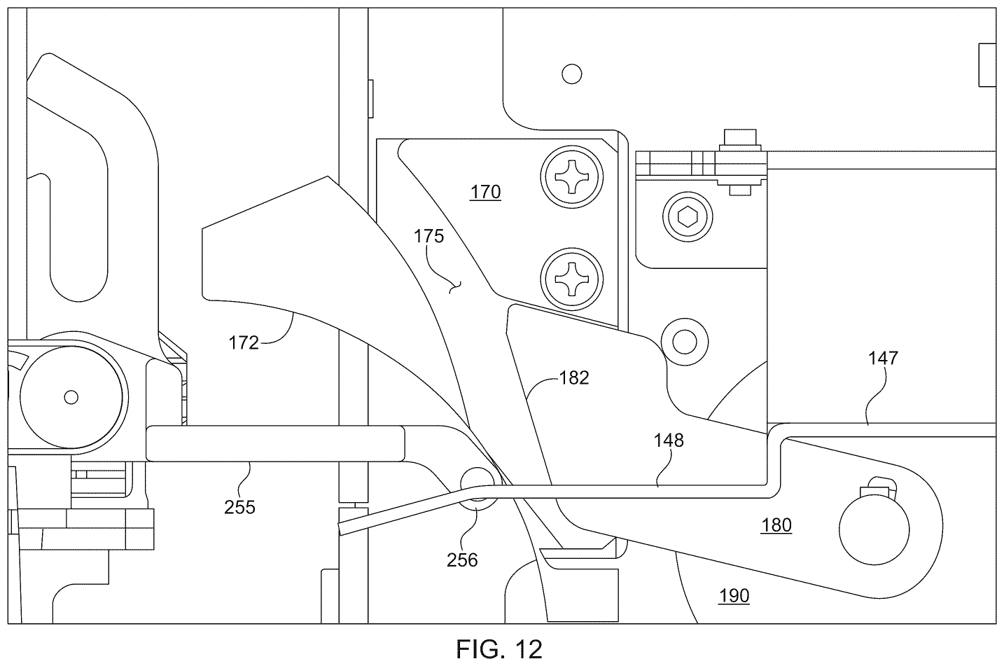

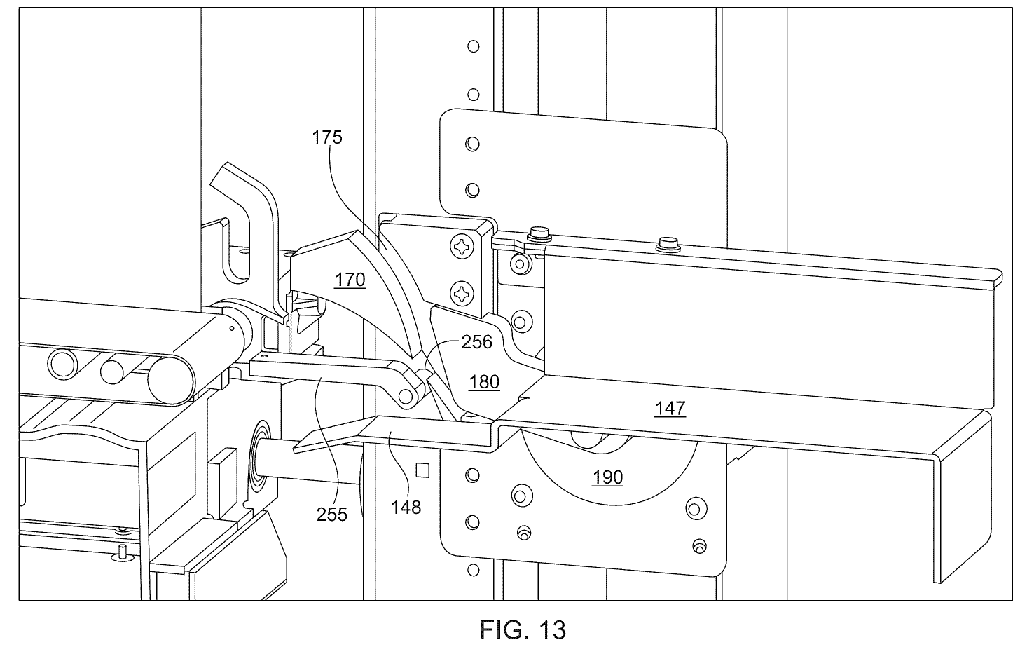

As shown in FIGS. 12-13, the second guide surface 175 is a slot that intersects with the guide surface 172. When the guide arm 180 is in the first position, the guide arm acts as a stop impeding the follower 256 from moving into the slot 175. When the guide arm 180 is in the second position, the follower 256 is free to move into engagement with the slot 175. The slot is configured to allow the follower 256 to follow a path that facilitates closing of the vehicle gate 240. For instance, the slot 175 may have an arcuate curvature configured similar to the arc that the follower 256 travels when the vehicle door 240 pivots from an opened position to a closed position.

The guide arm 180 may be connected with a drive mechanism 190 that drives the guide arm between the first and second positions. The drive mechanism may be any of a variety of actuable elements, such as a motor or rotary solenoid.

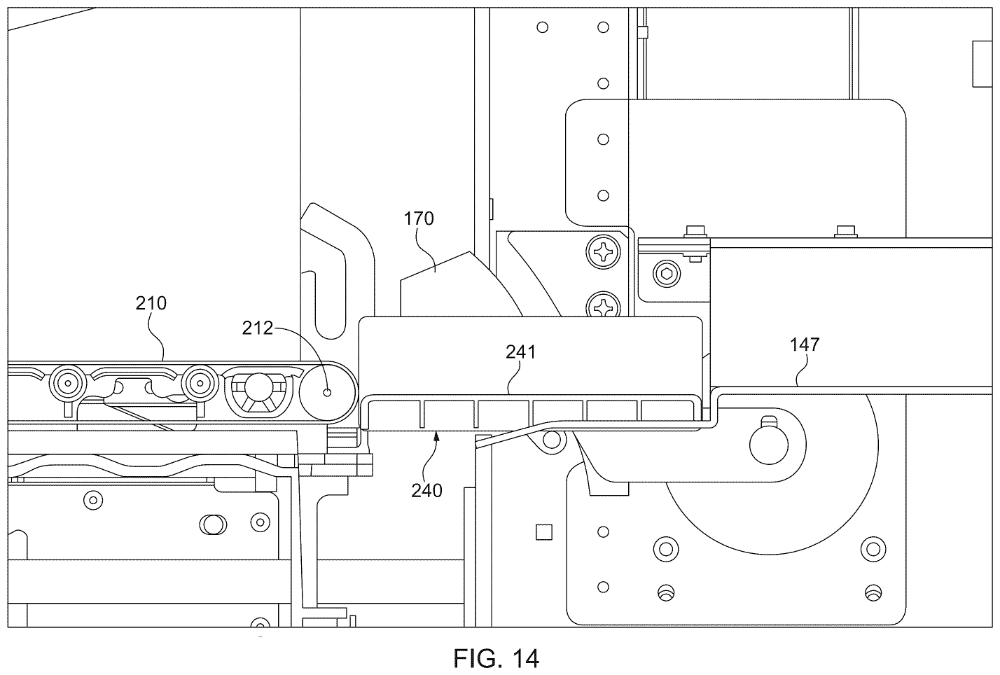

Referring again to FIGS. 11-13, in the present instance, the vehicle 200 moves along the track toward loading station 145. For instance, the vehicle may move along the lower horizontal track 130 to the loading column 140. At the loading column that vehicle moves upwardly towardly the loading station. The gate actuator 250 is actuated to move the arm to the partially open position. As the vehicle moves upwardly, the follower 256 on the arm 255 engages the guide surface 172 of the gate opener 170. The follower 256 follows the guide surface 172 and then the guide surface 182 on the guide arm 180. The gate opener 170 is positioned so that when the vehicle is positioned at the loading station 145, the inner surface 241 of the vehicle gate 240 is aligned with the input surface at the loading station 145 (e.g. loading platform 147 or conveyor 50) as shown in FIG. 14.

The input station may include a shelf for supporting the vehicle gate when the gate is open. As shown in FIG. 14, in the present instance, a gate support or shelf 148 is connected with the loading platform 147. The shelf supports the vehicle gate 240 when the gate is open. Additionally, the shelf is configured so that the inner surface of the gate 240 is aligned with the loading platform 147. In this way, the inner surface 241 of the gate can operate as a bridge so that an item can be pushed along the loading platform and onto the gate toward the loading surface of the vehicle, which in the present instance is the top of the conveyor 210.

The vehicle gate 240 may be configured so that the inner surface 241 of the gate is aligned with the loading surface 210 of the vehicle when the gate is opened. However, in the present instance, the vehicle gate is configured to maximize the payload area on top of the conveyor. Therefore, the inner surface 241 of the vehicle gate is positioned adjacent the end of the surface of the conveyor belt. In other words, the lower edge of the vehicle gate spans across the width of the vehicle and may be positioned adjacent the centerline of the end roller 212 that the conveyor is entrained. Accordingly, the inner surface 241 of the vehicle gate 240 may be disposed below the top edge of the loading mechanism 210 when the gate is open.

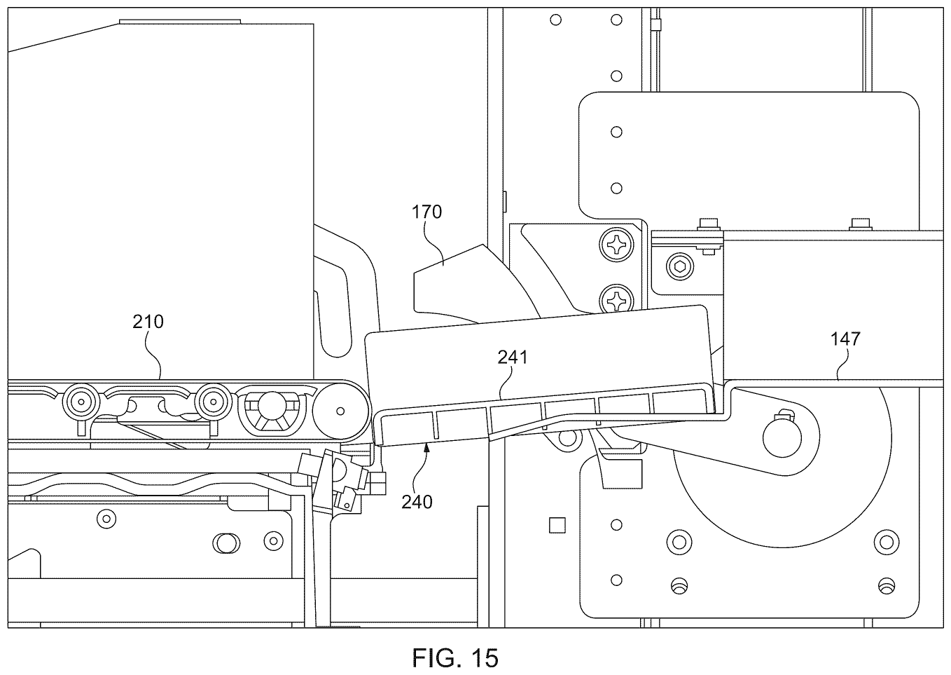

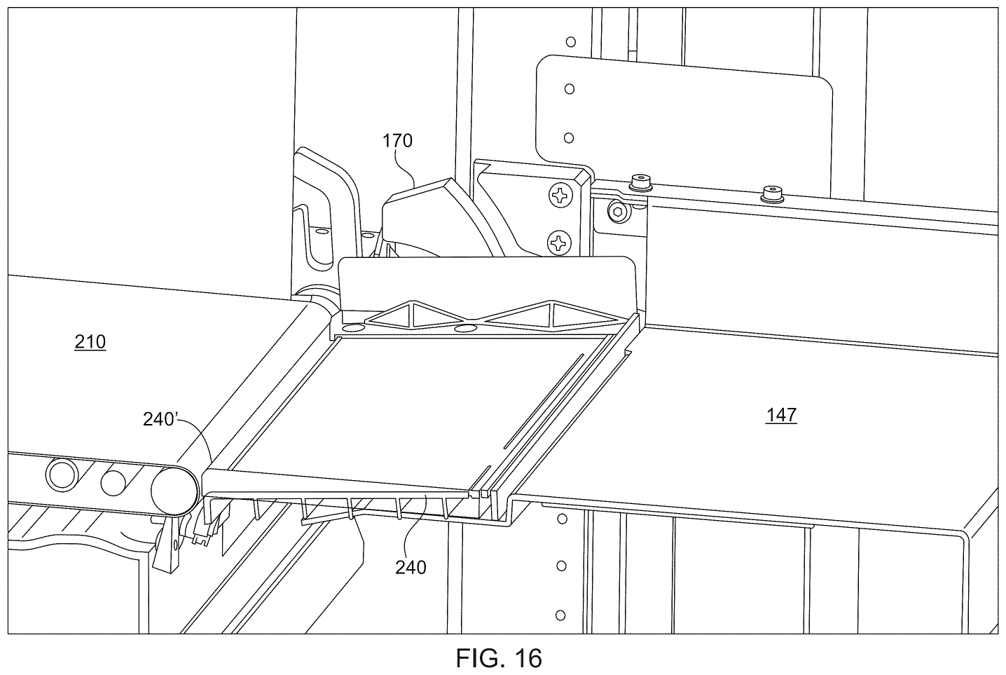

Since the inner surface of the vehicle gate 241 may be below the upper surface of the conveyor belt 210, items may tend to impact the end of the conveyor as can be seen in FIG. 14. Accordingly, the vehicle gate 240 may be formed so that a portion of the gate is displaceable relative to an outer portion of the vehicle gate. Specifically, referring to FIGS. 15-16, the vehicle gate may be configured so that the lower edge of the vehicle gate is displaceable relative to the upper edge of the gate. As shown in FIG. 15, when the vehicle is positioned at the loading station 145, the upper edge of the vehicle gate is aligned with the loading surface 147 while the lower edge of the vehicle gate is positioned at a lower point. As shown in FIG. 16, the central portion of the vehicle door 240 can be moved into the position designated 240′ in FIG. 16. In this position, the central portion of the vehicle door is displaced upwardly so that the lower edge of the vehicle door is aligned with or adjacent to the upper surface of the conveyor 210.

The vehicle gate 240, 242 may a substantially flat or planar structure. Referring to FIGS. 5, 6 and 10, in the present instance, the vehicle gate 240, 242 include side flaps or flanges 243, 245 respectively that extend along the height of the vehicle gates. The flanges 243, 245 overlap with side walls 231, 232 when the vehicle gates 240, 242 are in the upright position. Additionally, the side flanges 243, 245 have sufficient length so that the side flanges overlap with the side walls 231, 232 when the vehicle gates are partially open as shown in FIG. 7. In this way, the flanges reduce the opening between vehicle gate and the side walls that items may fall through when the gates are partially open.

In the above description, the vehicle gates 240, 242 are actuated by displacing a gate actuator 250 and displacing the 200 delivery vehicle relative to a gate opener. In the foregoing discussion, the vehicle is described as moving vertically relative to the gate opener 150 to open the gates. However, it should be appreciated that the mechanism may be modified so that displacement of the vehicle horizontally relative to gate opener is operable to open the gates.

Additionally, in the foregoing description, the vehicle gates 240, 242 are illustrated as being connected by a linkage 280 with a motor. The linkage may interconnect both vehicle gates 240, 242 with the motor 285 so that both doors are simultaneously partially opened and then fully opened when the vehicle is displaced. Alternatively, the linkage between the motor and the vehicle gates may be configured to allow the vehicle gates to be separately and selectively opened.

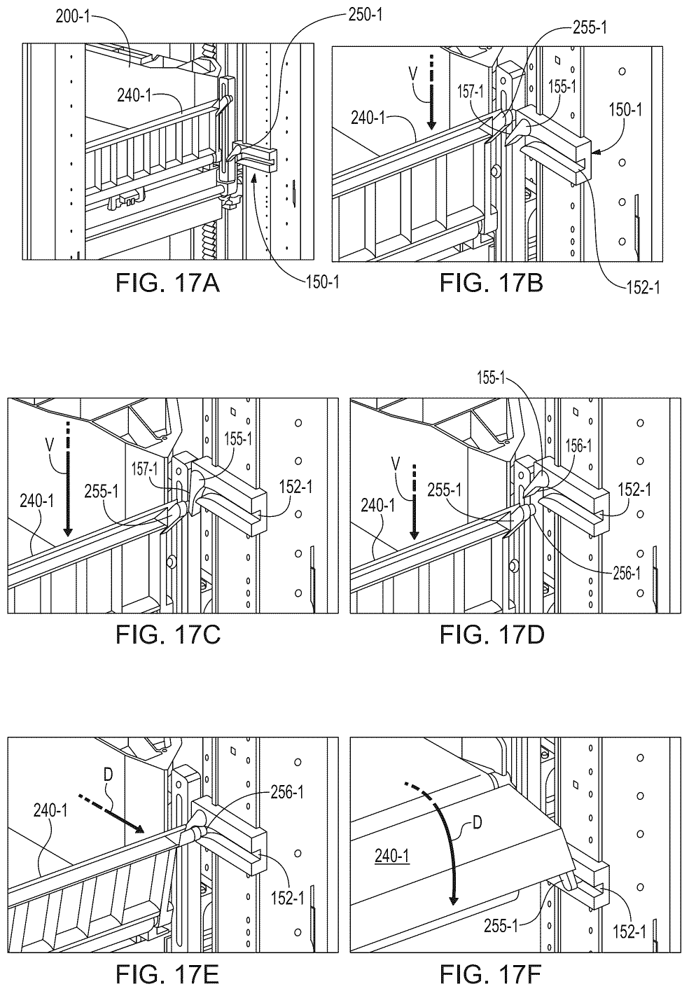

Referring now to FIG. 17, an alternate vehicle gate opening mechanism is illustrated. The vehicle is designated 200-1 and is substantially similar to the delivery vehicle 200 described above. The delivery vehicle 200-1 includes a gate actuator 250-1, however, the gate actuator 250-1 is not connected with a drive linkage to move the gate actuator outwardly as described above in connection with gate actuator 250. Instead of the gate actuator being displaceable, the system includes an alternate gate opener 150-1 that is displaceable.

The gate opener 150-1 may include a pawl-shaped element 155 that is displaceable between a first position (See FIGS. 17B, 17D & 17E) in which an end of the pawl extends outwardly toward the aisle to engage the gate actuator and a second position (See FIG. 17C) in which the end of the pawl extends downwardly to impede the gate actuator from engaging with the guide surface 152-1 of the gate opener 150-1. The pawl may be driven between the first and second positions by any of a variety of actuators, including solenoids and motors. However, in the present instance, a biasing element, such as a spring biases the pawl toward the first position.

The gate actuator 250-1 may include an elongated arm 255-1 and a follower 256-1 similar to the arm 255 and follower 256 described above. Additionally, the vehicle gate 240-1 may be similar to the vehicle gate described above. For instance, the vehicle gate 240-1 may be biased toward the closed position by a biasing element such as a torsion spring.

The gate opener 150-1 may include a guide surface 152-1 such as a curved slot that guides the follower 256-1 when the follower engages the guide surface and the vehicle is moved relative to the gate opener.

As shown in FIG. 17C, when the pawl 155-1 is disposed in the second position, the pawl impedes engagement between the follower 256-1 and the guide surface 152-1. However, as shown in FIG. 17D, when the pawl is disposed in the first position, the pawl permits engagement between the follower 256-1 and the guide surface 152-1. Further still, the pawl may guide or direct the follower 256-1 toward the guide surface 152-1. For instance, movement of the vehicle upwardly in the direction designated “V” in FIG. 17D displaces the follower 256-1 into engagement with the inner surface 156-1 of the pawl 155-1, which directs the follower toward the guide surface 152-1. In contrast, as shown in FIG. 17C, when the follower 256-1 engages the outer surface 157-1 of the pawl 155-1, the outer surface does not direct the follower 256-1 toward the guide surface 152-1.

Referring to FIGS. 17A, 17F, the operation of the alternate gate actuator/opener will be described. In FIG. 17A, the vehicle 200-1 is positioned in the aisle above a gate opener 150-1 positioned adjacent an output bin (e.g. bin 20). Movement of the vehicle downwardly in the direction designated “V” in FIG. 17B, displaces the gate actuator 250-1 on the vehicle toward the gate opener 155-1. Continued movement of the vehicle downwardly in the column displaces the follower arm 255-1 toward the pawl 155-1 so that follower 256-1 engages the outside surface 157-1 of the pawl. The follower engages the pawl thereby displacing the pawl from the first position to the second position illustrated in FIG. 17C. The pivoting of the pawl to the second position allows the vehicle to continue to move down the column until the follower 256-1 is below the end of the pawl. After the follower disengages the outer surface of the pawl 155-1, the pawl is free to pivot back into the first position as illustrated in FIG. 17D. In the present instance, a biasing element urges the pawl so that the pawl pivots from the second position illustrated in FIG. 17C to the first position illustrated in FIG. 17D.

After the vehicle is positioned below the gate opener with the pawl positioned in the first position, movement of the vehicle upwardly 200 relative to the gate opener 150-1 displaces the follower 256-1 into engagement with the inner surface 156-1 of the pawl. As the vehicle continues upwardly, the follower follows the inner surface of the pawl into engagement with the guide surface 152-1. Once the vehicle engages the guide surface 152-1, continued upward displacement of the vehicle drives the follower along the guide surface. As the follower 256-1 follows the guide surface 152-1, the follower displaces the arm 255-1. The arm 255-1 is connected with the pivotable vehicle gate 240-1 so that displacement of the arm opens the vehicle gate. Specifically, as shown in FIG. 17E, when the follower 256-1 engages the inner surface of the pawl, the gate is displaced in the direction designated “D” into a partially open position. Continued displacement of the follower pivots the gate in the direction designated “D” into the open position shown in FIG. 17F.

After the vehicle gate is opened, an item can be transferred onto the vehicle or discharged from the vehicle as discussed above in connection with discharging items into the bins 20 and loading items onto the vehicles at the loading station 145. Once an item is transferred onto or off of the vehicle, the vehicle is displaced relative to the gate opener 150-1 to close the vehicle gate 240-1. For instance, referring to FIG. 17F, the vehicle may be displaced downwardly within the column to move the follower 256-1 out of engagement with the gate opener 150-1. Once the follower 256-1 disengages the gate opener, the gate is displaced back into the closed position. For example, a biasing element may impart a torsional force on the vehicle gate 240-1 to close the vehicle gate 240-1 when the follower 256-1 disengages the gate opener.

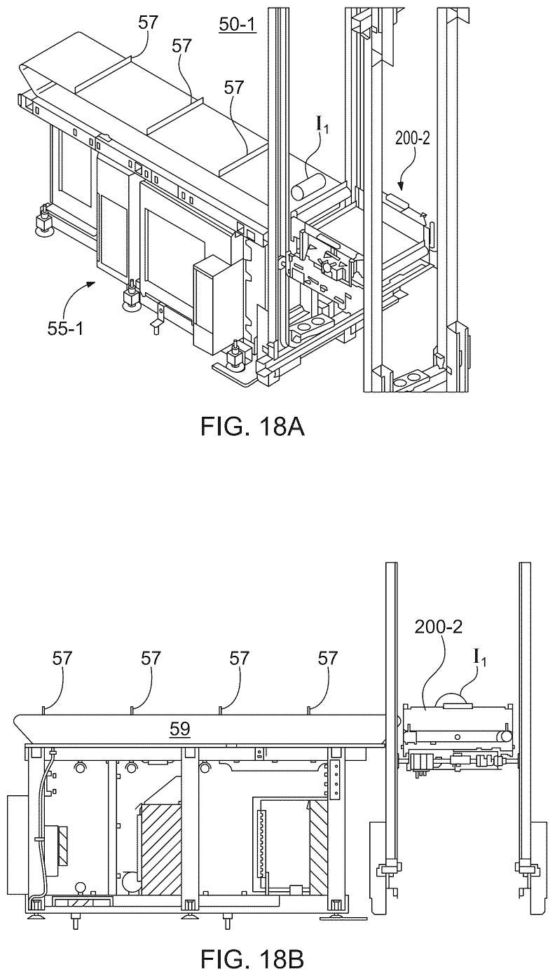

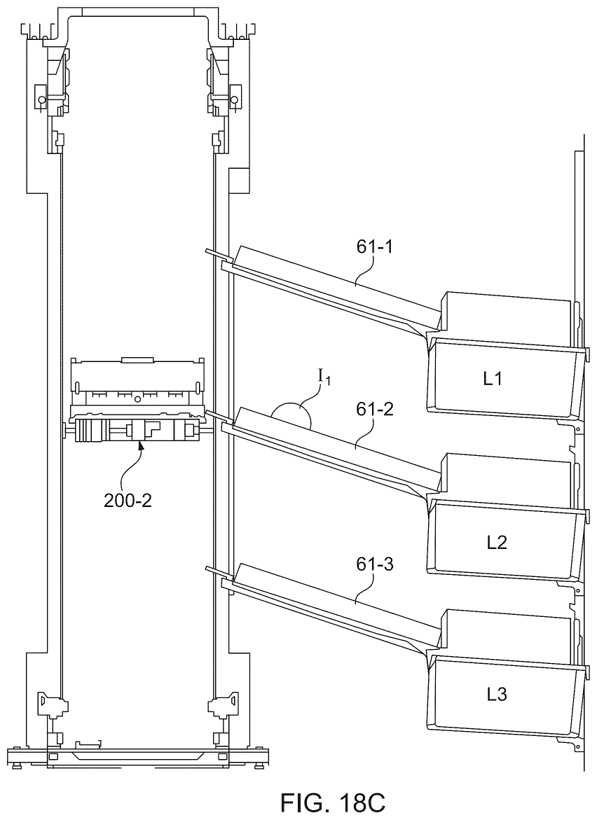

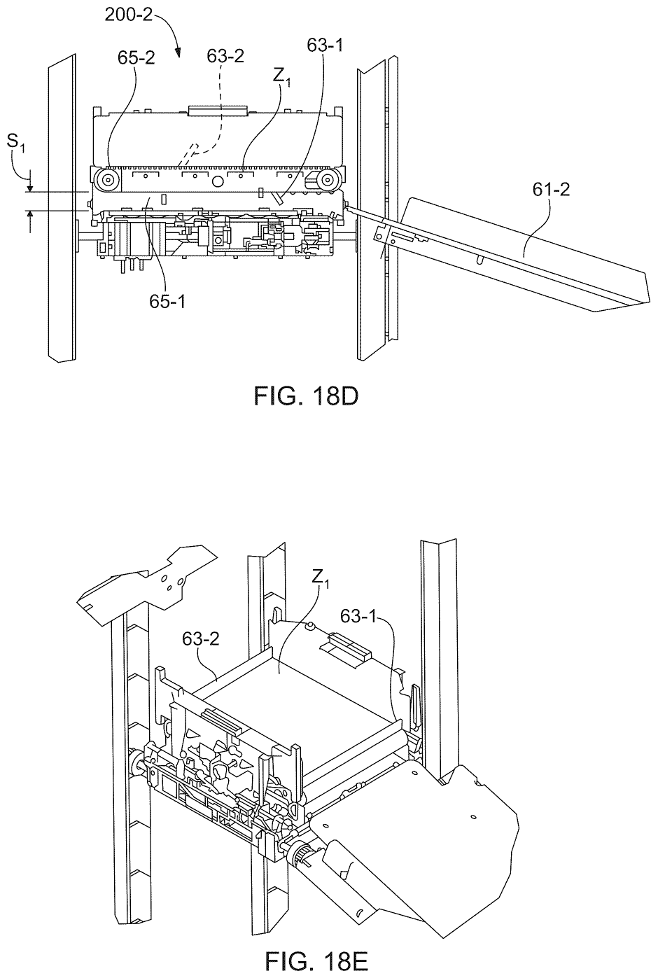

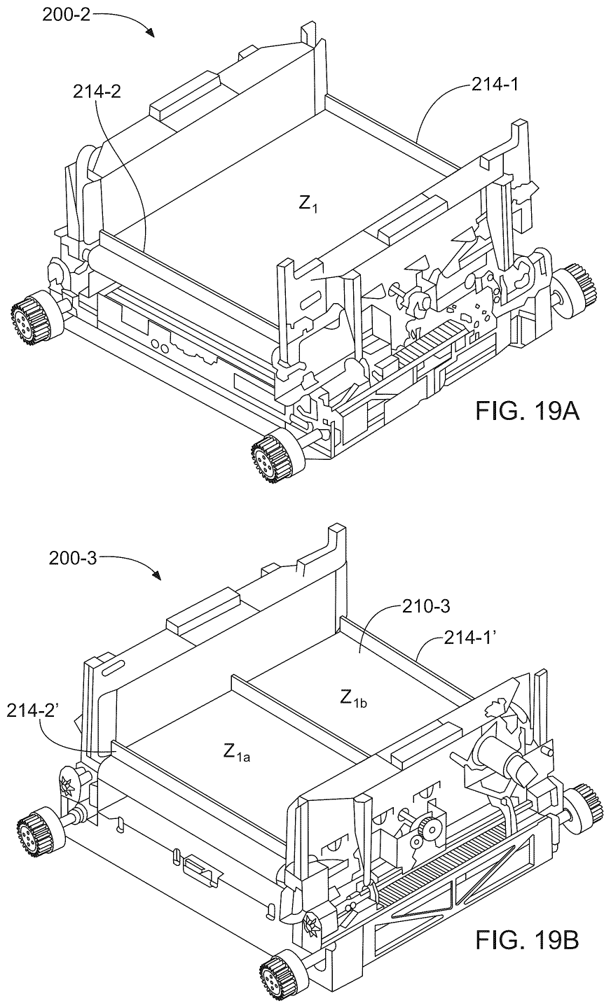

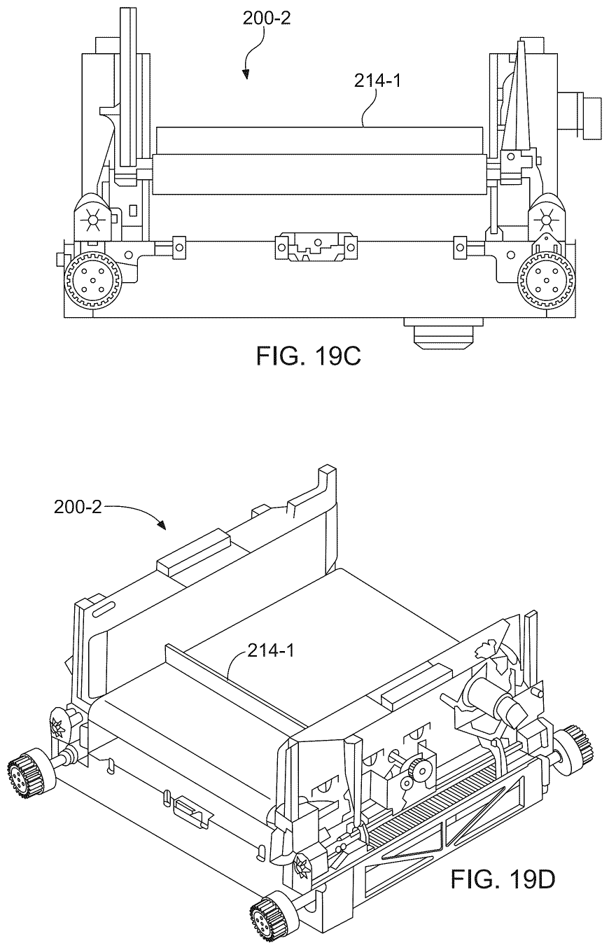

Referring now to FIGS. 18A-19D another alternate embodiment is illustrated in which the material handling system incorporates elements for retaining products to impede products from falling off the feed conveyor or off of the delivery vehicle.

FIG. 18A is a perspective view of a material handling system having functionality similar to that depicted in FIG. 1 but incorporating a modified input station 50-1 which utilizes a feed conveyor belt 55-1 having retention assistant walls 57 formed or otherwise provided at spaced apart intervals across the conveyor surface, the retention assistant walls being cooperable with similar retention features as displaceable walls 63-1 and 63-2 formed or otherwise provided on the carrier surface 210-2 of a movable transfer mechanism as delivery vehicle 200-2, according to one or more alternate embodiments consistent with the present disclosure. In an exemplary embodiment the carrier surface is defined by an endless belt trained over a pair of spaced apart rollers (not shown). FIG. 18B is a side elevation view of the material handling system of FIG. 18A, depicting relative orientations of the feed conveyor surface and the carrying surface 210-2 of delivery vehicles as delivery vehicle 200-2

In an embodiment, the retention assistant walls are formed by cleats 57 in which define retention wall surfaces that projects upwardly from the surface of the conveyor belt 55-1. Each cleat may have any of a number of configurations. For instance, the cleat 57 may extend across substantially the entire width of the conveyor belt 55-1. Each of cleats 57 cooperates with sidewalls 59 (FIG. 18B) of input station 50-1 to form a series of contained areas or pockets such as the one in which item I₁ is positioned in FIG. 18B. Each pocket is bounded on two sides by surfaces of opposing cleats 57 and on two sides by the opposing walls of the input station. The cleats retain items within each pocket as the conveyor moves the item forward to the delivery vehicle 200-2 disposed at the loading position shown in FIGS. 18A and 18B. The cleated input belt may be used with the delivery vehicles described above having moveable gates that retain items on the delivery vehicles.

FIG. 18C is a cross-sectional side view of the embodiment depicted in FIGS. 18A and 18B, taken across a vertical plane to depict the arrangement of respective storage locations L₁, L₂, and Lₐ which are correspondingly disposed at the distal end of an associated discharge chute, indicated generally at 61-2, 61-2 and 61-3, respectively, and to further depict the relative position of a delivery vehicle as delivery vehicle 200-2 during and subsequent to the transfer of an item as item 11 onto one of the discharge chutes as discharge chute 61-2.

FIG. 18D is a partial cross-sectional side view taken across the same vertical plane as used in the depiction of FIG. 18C but enlarged to show a gap indicated generally at S₁ beneath the downwardly facing carrier surface portion 65-1 defined by a transfer mechanism such as conveyor belt 210-2 of delivery vehicle 200-2. FIG. 18E is a partial perspective view of the material handling system of claims 18A to 18D following restoration of first and second retention assistant walls 63-1 and 63-2 to their respective first positions to define a circumscribed retention zone Z₁ of delivery vehicle 200-2 on the upwardly facing surface portion 65-2 thereof.

Gap S₁ is dimensioned and arranged to provide clearance for movement of a first retention assistant wall 63-1 of a retention assistant from a first position shown in FIG. 18E to a second position which, in the embodiment of FIGS. 18A to 18E extends downwardly relative to and beneath the downwardly facing surface portion 65-1.

Displacement of the first and second retention assistant walls as those defined by cleats from their respective positions shown in FIG. 18E, together with the carrier surface—such as by movement of the surface of conveyor belt 210-2 of delivery vehicle 200-2 in a first transfer direction as transfer direction D1 toward chute 61-2 (FIG. 18D) and storage location L2 (FIG. 18C)—places a first retention assistant wall as cleat 63-1 in its second position shown in FIG. 18D to thereby open a first transfer passage which permits a product or other item to exit the retention zone Z₁ and to be transferred onto a surface of chute 61-2. As will be readily ascertained by the artisan of ordinary skill, reversal of the conveyor belt direction in a direction D2 opposite to direction D1 to the positions shown in FIG. 18E restores the retention assistant walls of cleats 63-1 and 63-2, while sufficient continued movement of conveyor belt 210-2 will eventually place a second retention assistant wall as cleat 63-2 in its section position symmetrically equivalent to that of 63-1 in FIG. 18D and thereby open a second transfer passage which permits a product or other item to exit the retention zone Z₁ and to be transferred onto a surface of a chute or other discharge assistant facing in a direction opposite that of chute 61-2 (were such discharge assistant to be present).

FIG. 19A is a perspective view of an exemplary embodiment of a delivery vehicle 200-2 for use as a delivery mechanism in a material handling system consistent with one to which FIGS. 18A to 18E are applicable, the delivery vehicle having an endless belt 210-2 and first and second cleats 214-1 and 214-2 which, as already described in connection with FIGS. 18A to 18E, define—together with lateral side walls of the delivery vehicle—a circumscribed item retention zone Z₁ when the first and second retention assistant walls as those defined by first and second cleats 214-1 and 214-2 are in their respective first positions,

FIG. 19B is a perspective view of an alternative exemplary embodiment of a delivery vehicle 200-3 for use as a delivery mechanism in a material handling system consistent with FIGS. 18A to 18E, the delivery vehicle having an endless conveyor belt 210-3 and first, second, and third retention assistant walls in the form of cleats 214′1′, 214-2′ and 214-3′, respectively, which, in combination with lateral side walls of the delivery vehicle, define first and second circumscribed item retention zones Z_{1A} and Z_{1B} when each of the retention assistant walls are in their respective first positions, it being understood that sufficient displacement of the retention assistant wall 214-1′ in a first direction of transfer and displacement of the retention wall 214-2′ in a second direction opposite to the first direction of transfer, yields the same movement into a corresponding second retention assistant wall position as described in connection with FIGS. 18A-18E and FIG. 19A.;

FIG. 19C is a side elevation view depicting a delivery vehicle according the embodiment of FIG. 19A or FIG. 19B, in which a retention assistant wall in a position which closes the transfer passage through which an item to be delivered could otherwise be transferred to a target storage location as previously described in connection with FIGS. 18A to 18E, and FIG. 19D is a perspective view of a delivery vehicle in which a retention assistant wall has been displaced from the first position shown in FIGS. 18A, 19A and/or 19C, to the second position shown in 18D whereby an item as item 11 is no longer impeded from passing through a transfer passage formed by the lateral walls and carrying surface of a delivery vehicle as delivery vehicle 200-2.

It will therefore be understood that cleats 214 of each delivery vehicle as delivery vehicle 200-2 are spaced apart along the length of the conveyor belt. In embodiments consistent with the present disclosure, the position of the cleats are controlled when items are loaded onto the delivery vehicle so that the cleat 214 moves away from the loading station 50-1 as an item is conveyed onto the delivery vehicle from the input station. In such embodiments, the cleats are positioned and controlled so that the first cleat is positioned adjacent the rear end of the vehicle when an item is loaded onto the vehicle and a second cleat is positioned adjacent the front end of the vehicle. In this way the pocket or retention zone Z₁ formed by the two cleats and the two side walls 231-1 and 231-2 is substantially the entire area of the upper surface of the conveyor belt 210-2.

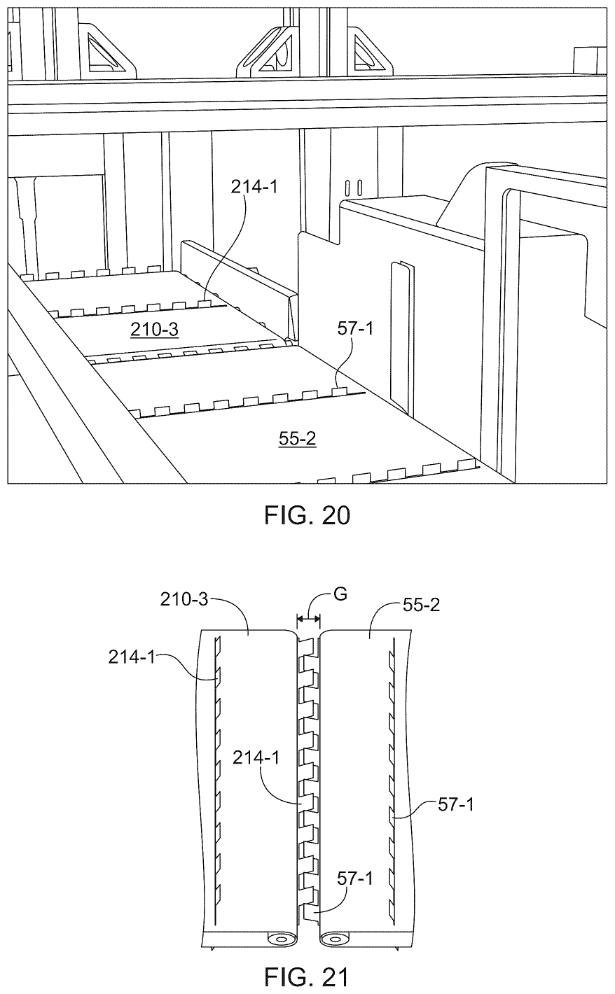

Referring to FIGS. 20-21, an alternate cleat design is illustrated for the feed conveyor and the delivery vehicle. Specifically, the cleats on the feed conveyor may be formed and positioned to mesh with the cleats on the delivery vehicle.

Specifically, a gap may be formed between the end or edge of the conveyor 210-3 of the delivery vehicle and the end or edge of the feed conveyor 55-2. In FIG. 21, this gap is designated “G”. This gap allows the vehicle to move relative to the feed conveyor. For instance, the vehicle may move horizontally or vertically relative to the feed conveyor. The cleats 214-1 on the conveyor 210-3 project partway into the gap “G”. Similarly, the cleats 57-1 on the feed conveyor 55-2 project into the gap “G”.

The cleats 214-1 and 57-1 may be configured so that the cleats substantially bridge the gap “G” to impede items falling through the gap. For instance, the height of the cleats 214-1 combined with the height of the cleats 57-1 may be substantially equal to the width of the gap “G”. Further still, as shown in FIG. 21, the height of the cleats 214-1 on the transfer conveyor 210-3 and the height of the cleats 57-1 on the feed conveyor 55-2 may be larger than the width of the gap “G”. In order to ensure that the cleats on the vehicle conveyor do not impede or interfere with the cleats on the feed conveyor, the cleats may be configured to mesh, similar to teeth, as shown in FIG. 21. It should be noted that FIG. 21 is a simplified diagrammatic view of the vehicle conveyor 214 without other features of the delivery vehicle and the feed conveyor is illustrated without other features of the input station.

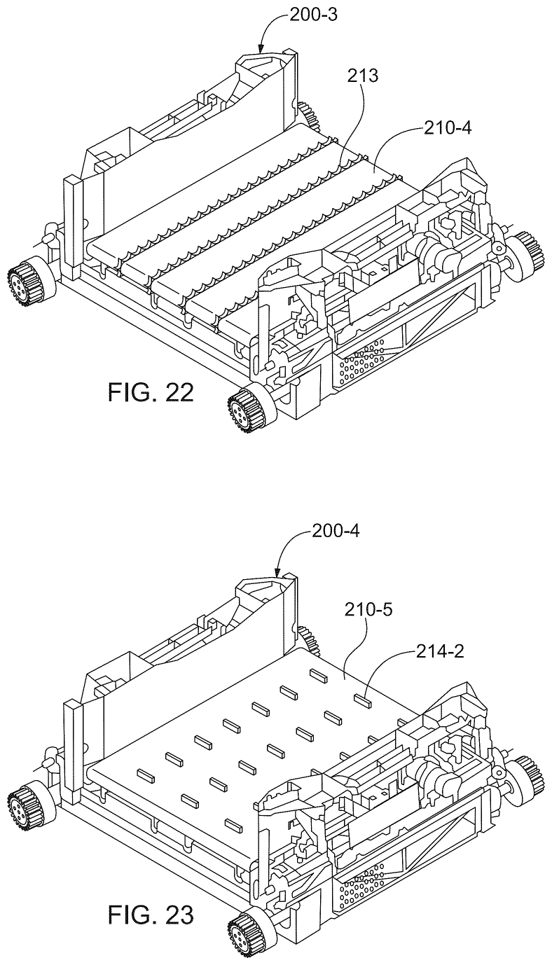

Referring to FIG. 22, an alternate delivery vehicle 200-3 is illustrated. This delivery vehicle includes an alternate cleat version 213. The cleats 213 run along the length of the conveyor belt 210-4 rather than across the width. The conveyor may include a plurality of cleats spaced apart across the width of the conveyor. Additionally, the cleats may include a plurality of recesses along the length of the cleat 213. Optionally, the recesses formed in the cleats may be aligned with corresponding recesses in the cleats across the width of the conveyor belt. The aligned recesses form troughs for holding items on the belt.

Referring to FIG. 23, yet another alternate delivery vehicle 200-4 is illustrated. The delivery vehicle includes another alternative cleat design. The cleats 214-2 are spaced apart across the width of the belt 210-5 and along the length of the belt 210-5. In the present instance, the cleats optionally form an array or rows and columns of cleats formed across the width of the conveyor belt 210-5 and along the length of the conveyor belt. Additionally, the feed conveyor for the input station may include cleats the form a series of rows and//or columns that align with the spaces between the cleats 214-2 on the conveyor belt to form a partial bridge of the gap between the vehicle and the feed conveyor similar to the embodiment illustrated in FIG. 21.

The order of methods described herein may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

Accordingly, while the foregoing is directed to embodiments of the present invention, other and further embodiments of the invention may be devised without departing from the basic scope thereof, and the scope thereof is determined by the claims that follow.

We claim:

1. A method for delivering items to a storage assembly having a plurality of storage locations, comprising the steps of:
providing a delivery mechanism movable along a path encompassing an input station and a target storage location of the plurality of storage locations, wherein the delivery mechanism includes
a support defining a carrying surface dimensioned and arranged to receive an item to be delivered and to support the item to be delivered as the delivery mechanism moves along the path,
a first wall extending along a first side of the carrying surface, and
a second wall extending along a second side of the carrying surface and opposing the first wall so that a first transfer passage is formed proximate a first end of the support and a second transfer passage is formed proximate a second end of the support,
wherein the delivery mechanism further includes a retention assistant comprising a displaceable wall dimensioned and arranged to extend transversely relative to the first and second walls, the displaceable wall being displaceable between a first position substantially orthogonal to an item support plane defined by the carrying service to thereby prevent an item to be delivered from moving into the first transfer passage and a second position permitting movement of an item to be delivered into and through the first transfer passage;
moving the delivery mechanism with a first item to be delivered along a path to a position proximate a first target storage location;
displacing the displaceable wall from the first position to the second position; and
transferring the first item from the delivery mechanism to the first storage location after the step of moving the delivery mechanism.

2. The method of claim 1, wherein the retention assistant provided during the providing is a first retention assistant, the retention assistant further comprising a second retention assistant including a second displaceable wall dimensioned and arranged to extend transversely relative to the first and second walls, the second displaceable wall being displaceable between a third position substantially orthogonal to the item support plane defined by the carrying service and a fourth position permitting movement of an item to be delivered into and through the second transfer passage, the method further including
moving the delivery mechanism with a second item to be delivered along a second path to a position proximate a second target storage location;
displacing the second displaceable wall from the third position to the fourth position; and
transferring the second item from the delivery mechanism to the second target storage location after the step of moving the delivery mechanism.

3. The method of claim 1, wherein the displaceable wall of the first retention assistant is a first door adjacent the first end and displaceable between a closed position in which the door extends across the first transfer passage to impede transfer of items through the first transfer passage and an open position in which the first door is displaced away from the first transfer passage to permit transfer of items through the first transfer passage;
wherein the first retention assistant further includes a first actuator connected with the first door to displace the door between the closed and opened positions;
wherein moving the delivery mechanism with a first item to be delivered along a path to a position proximate a first target storage location includes moving the delivery mechanism toward a second actuator so that the first actuator engages the second actuator to displace the first door into the open position; and
wherein transferring the first item from the delivery mechanism to the first storage location is performed after moving the delivery mechanism toward a second actuator.

4. The method of claim 3, further comprising a step of moving the delivery mechanism from the first storage location to disengage the first actuator from the second actuator.

5. The method of claim 4, further comprising a step of displacing the first door into the closed position in response to the step of disengaging the first actuator from the second actuator.

6. The method of claim 5, wherein the delivery mechanism comprises a biasing element biasing the first door toward the closed position and wherein the step of displacing the first door into the closed position comprises releasing the door so that the biasing element displaces the door toward the closed position.

7. The method of claim 6 wherein moving the delivery mechanism toward a second actuator comprises displacing the first actuator against the bias of the biasing element.

8. The method of claim 3, wherein the delivery mechanism is a delivery vehicle, the method further including:
driving the delivery vehicle toward a loading station; and
driving the first actuator toward a third actuator adjacent the loading station to displace the first actuator into engagement with the third actuator to open the first door.

9. The method of claim 2, wherein the support of the delivery mechanism includes a conveyor belt defining the carrying surface and wherein the first and second displaceable walls are cleats disposed across the conveyor belt at a spacing sufficient to accommodate receipt of an item from an feed conveyor and retention of a received item between the first and second cleats during movement of the delivery mechanism, the method further including
controlling movement of the feed conveyor and of the delivery mechanism conveyor to transfer an item from a surface of the feed conveyor, through the first transfer passage, and onto the carrying surface of the delivery mechanism;
controlling movement of the delivery mechanism conveyor so that the transferred item is retained in a retention pocket defined by the first and second walls of the delivery mechanism and surfaces of the first and second cleats, during movement of the delivery mechanism to the first target storage location.

10. A method for delivering items to a plurality of sortation locations using a plurality of vehicles displaceable along a vehicle path, comprising the steps of:
loading an item onto a first vehicle;
displacing a product retainer relative to a first transfer passage on the first vehicle to impede items from being displaced off the first vehicle through the first transfer passage;
displacing the first vehicle toward a first of the sortation locations, wherein a gap is formed between the first transfer passage and the first sortation location;
displacing the product retainer into the gap so that the product retainer operates as a bridge on which the item is displaceable; and
displacing the item across the bridge and toward the first sortation location.

11. The method of claim 10 comprising the step of displacing the product retainer away from the gap and into the first transfer passage after the step of displacing the item across the bridge.

12. The method of claim 10 wherein the step of displacing the product retainer comprises the step of displacing the first vehicle toward the first sortation location so that a first actuator on the first vehicle engages a second actuator adjacent the first sortation location to displace the product retainer.

13. The method of claim 10 wherein the first vehicle comprises a conveyor on which the item is loaded and the product retainer comprises an element projecting upwardly from the surface of the conveyor, wherein the step of displacing the product retainer comprises displacing the conveyor.

14. The method of claim 10 wherein the step of displacing the product retainer comprises pivoting the product retainer from a generally vertical position to a generally horizontal position.

15. A delivery vehicle operable with a material handling system having a plurality of storage locations and a gate opening mechanism adjacent one of the storage locations, wherein the delivery vehicle comprises:
a drive system for driving the vehicle to one of the destination areas;
a motor for driving the drive system;
a transfer mechanism for transferring items between the vehicle and the storage locations wherein the transfer mechanism comprises a surface for receiving an item to be conveyed to one of the storage locations;
a pair of opposing walls extending upwardly relative to the surface and spaced apart from one another so that at least a portion of the surface is between the opposing walls, wherein the opposing walls are dimensioned and arranged to facilitate transfer of items off the surface at a first end of the surface and to facilitate transfer of items off the surface at a second end of the surface;
a first gate positioned adjacent the first end of the surface and operable between an opened position and a closed position, wherein in the closed position the first gate extends across the first transfer passage and operates as a stop to impede displacement of items off the surface at the first end and in the opened position the first gate allows displacement of items off the surface at the first end;
a first actuator connected with the first gate and operable between a first position in which the first gate is in the closed position and a second position in which the first gate is in the opened position wherein the first actuator is configured to cooperate with the gate opening mechanism so that displacement of the delivery vehicle relative to the gate opening mechanism is operable to displace the first actuator into the second position.

16. The delivery vehicle of claim 15 comprising a biasing element biasing the first gate from the opened position to the closed position.

17. The delivery vehicle of claim 15 or 16 wherein the first actuator comprises a pivotable arm.

18. The delivery vehicle of claim 17 wherein the first actuator comprises a follower connected to the pivotable arm.

19. The delivery vehicle of claim 18 wherein the follower is configured to follow a guide surface of the gate opening mechanism to displace the first actuator between the first and second positions.

20. The delivery vehicle of any of claims 15-19 comprising a drive element operable to drive the first actuator from the first position to a third position that is between the first position and the second position.

21. The delivery vehicle of claim 20 wherein the first actuator is configured so that in the first position the delivery vehicle is displaceable relative to the gate opening mechanism without engaging the gate opening mechanism and in the third position the first actuator is engageable with the gate opening mechanism when the delivery vehicle is displaced relative to the gate opening mechanism.

22. The delivery vehicle of any of claims 15-21 wherein the delivery vehicle comprises a drive system configured to drive the delivery vehicle horizontally and vertically.

23. The delivery vehicle of any of claims 15-22 comprising a second gate positioned adjacent the second end of the surface and operable between an opened position and a closed position, wherein in the closed position the second gate extends across the second opening and operates as a stop to impede displacement of items off the surface at the second end and in the opened position the second gate allows displacement of items off the surface at the second end.

24. The delivery vehicle of claim 23 comprising a second actuator connected with the second gate and operable between a first position in which the second gate is in the closed position and a second position in which the second gate is in the opened position wherein the second actuator is configured to cooperate with the gate opening mechanism so that displacement of the delivery vehicle relative to the gate opening mechanism is operable to displace the second actuator into the second position.

25. The delivery vehicle of claim 24 wherein the first and second actuators are linked by a connection that displaces one of the first and second actuators in response to displacement of the other of the first and second actuators.

26. A material handling system, comprising
a plurality of storage locations;
a first actuator adjacent one of the storage locations;
a plurality of delivery vehicles, wherein a first of the delivery vehicles comprises:
a motor for driving the delivery first vehicle;
a transfer mechanism for transferring items between the first vehicle and the storage locations wherein the transfer mechanism comprises a surface for receiving an item to be conveyed to one of the storage locations;
a pair of opposing walls extending upwardly relative to the surface and spaced apart from one another so that at least a portion of the surface is between the opposing walls, wherein the opposing walls are dimensioned and arranged to facilitate transfer of items off the surface at a first end of the surface and to facilitate transfer of items off the surface at a second end of the surface;
a first gate positioned adjacent the first end of the surface and operable between an opened position and a closed position, wherein in the closed position the first gate extends across the first transfer passage and operates as a stop to impede displacement of items off the surface at the first end and in the opened position the first gate allows displacement of items off the surface at the first end;
a second actuator connected with the first gate and operable between a first position in which the first gate is in the closed position and a second position in which the first gate is in the opened position wherein the second actuator is configured to cooperate with the first actuator so that displacement of the delivery vehicle relative to the first actuator is operable to displace the second actuator into the second position.

27. The system of claim 26 wherein the first actuator comprises a guide surface and the second actuator comprises a follower configured to follow the guide surface.

28. A material handling system, comprising:
a plurality of storage locations;
an input station;
a plurality of delivery mechanisms each being dimensioned and arranged to receive an item at the input station and each being movable along a path encompassing the input station and a corresponding target storage location of the plurality of storage locations;
wherein each delivery mechanism includes
a transfer mechanism defining a carrying surface dimensioned and arranged to receive an item to be delivered from the transfer station and to support the item to be delivered as the delivery mechanism moves along a respective path to a corresponding target storage location,
a first wall extending along a first side of the carrying surface, and
a second wall extending along a second side of the carrying surface and opposing the first wall so that a first transfer passage is formed proximate a first end of the support and a second transfer passage is formed proximate a second end of the support,
a retention assistant comprising a displaceable wall dimensioned and arranged to extend transversely relative to the first and second walls, the displaceable wall being displaceable between a first position substantially orthogonal to an item support plane defined by the carrying service to thereby prevent an item to be delivered from moving into the first discharge opening and a second position permitting movement of an item to be delivered into and through the first discharge opening, wherein the displaceable wall is one of displaceable with or displaceable relative to the carrying surface; and
a motor controllable to transfer the first item from the carrying surface of the transfer mechanism to the first storage location while the displaceable wall is in the second position.

29. The material handling system of claim 28, wherein the retention assistant of each delivery mechanism is a first retention assistant, the system further comprising a second retention assistant including a second displaceable wall dimensioned and arranged to extend transversely relative to the first and second walls, the second displaceable wall being displaceable between a third position substantially orthogonal to the item support plane defined by the carrying service and a fourth position permitting movement of an item to be delivered into and through the second transfer passage.

30. The material handling system of claim 28, wherein each delivery mechanism is a delivery vehicle movable along a corresponding vertical loop path having segments adjacent a discharge area of the feed conveyor and at least a target storage location of the plurality of storage locations.

31. The material handling system of claim 30, wherein each delivery vehicle includes a respective motor for driving movement of the delivery vehicle along a corresponding path to a destination.

32. The system of claim 29, wherein the transfer mechanism of each delivery mechanism includes a conveyor belt defining the carrying surface and wherein the first and second displaceable walls are cleats disposed across the conveyor belt at a spacing sufficient to accommodate receipt of an item from a feed conveyor and retention of a received item between the first and second cleats during movement of the delivery mechanism.

33. The system of claim 32, further including a first controller configured to control movement of the feed conveyor to initiate transfer an item from a surface of the feed conveyor, through the first transfer passage, and onto the carrying surface of the delivery mechanism conveyor belt.

34. A method for transporting an item upon a carrying surface of a delivery mechanism, the carrying surface defining a retention zone bounded by first and second lateral walls and first and second retention assistant walls,
wherein the first and second walls respectively define corresponding lateral wall surfaces disposed transverse to a direction of delivery mechanism travel along a path extending from an input station to a target storage location, each of the lateral wall surfaces being oriented to impede lateral movement of an item out of the retention zone,
wherein the first retention assistant wall is disposed transverse to the first and second lateral wall surfaces and is displaceable from a first position impeding movement of an item out of the retention zone to a second position enabling movement of an item out of the retention zone and in a first transfer direction: and
wherein the second retention assistant wall is disposed transverse to the first and second lateral wall surfaces, is spaced apart from the first retention assistant wall, and is one of non-manipulable out of a position impeding movement of an item out of the retention zone or displaceable from a first position impeding movement of an item out of the retention zone to a second position enabling movement of an item out of the retention zone and in a second transfer direction opposite the first transfer direction; the method comprising
at the input station, positioning an item within the retention zone and onto the carrying surface of the delivery mechanism;
while the first and second retention assistant walls are disposed in positions which impede movement of the positioned item out of the retention zone, advancing the delivery mechanism from the input station and along the path while the positioned item is free to move upon the carrying surface and within the boundaries of the retention zone despite changes in at least one of delivery mechanism direction of travel or delivery mechanism rate of travel;
from a position proximate a target storage location along the path, displacing the second retention assistant wall from the first position to the second position and operating a transfer mechanism of the delivery mechanism to move the item in the first transfer direction, out of the retention zone, and into the target storage location.

35. The method according to claim 34, wherein each path traveled by the delivery mechanism is a vertical loop path which encompasses the input station and a target storage location of a plurality of storage locations, wherein the input station includes an feed conveyor for feeding items onto the delivery mechanism, and wherein the second retention assistant wall is a displaceable wall, the method further comprising:
returning the delivery mechanism from a prior target storage location to the input station by movement along a first vertical loop path;
at the input station, operating the feed conveyor to transfer a second item to be delivered onto the carrying surface while the first retention assistant wall is displaced into the second position;
displacing the first retention assistant wall into the first position;
while each of the first and second retention assistant walls are disposed in a corresponding first position to impede movement of the positioned item out of the retention zone, advancing the delivery mechanism from the input station and along a second vertical loop path to a second target storage location;
from a position proximate the second target storage location, displacing the second retention assistant wall from the first position of the second retention assistant wall to the second position of the second retention assistant wall; and
operating the transfer mechanism to move the item in the second transfer direction, out of the retention zone, and into the second target storage location.

36. The method according to claim 34, wherein the positioning includes placing an item directly onto the carrying surface while the retention zone is defined by the first and second lateral wall and the first and second retention assistant walls.

37. The method according to claim 35, wherein the carrying surface is defined by an endless belt looped around two rollers, and wherein operating the transfer mechanism comprises actuating a motor to advance the endless belt in at least one of the first transfer direction or the second transfer direction.

38. The method according to claim 37, wherein the first and second retention assistant walls are defined by first and second elongated cleats which are separated from one another by a distance sufficient to form, with the lateral wall surfaces, a retention zone, and wherein displacing the first retention assistant wall into the first position includes actuating the motor to advance the endless belt such that the first and second elongated cleats are upwardly facing and define boundaries of the retention zone transverse to the first and second transfer directions.

39. The method according to claim 38, wherein the first and second retention assistant walls define surfaces which extend from the endless belt by a distance of from about 0.5 cm to about 3.75 cm.

40. The method according to claim 38, wherein the first and second retention assistant walls define surfaces which are substantially orthogonal to a plane defined by the carrying surface.

41. The method according to claim 38, wherein the first and second retention assistant walls define surfaces which bound portions of the retention zone and which are disposed in planes that converge relative to one another and form acute angles relative to the carrying surface, whereby an irregular item which shifts upon the carrying surface during positioning onto or travel of the delivery mechanism is more likely to contact a portion of the first and/or second retention assistant wall disposed further from the carrying surface than a portion of the first and/or second retention assistant wall disposed closer to the carrying surface.

42. A material handling system, comprising:
a plurality of storage locations;
an input station;
a plurality of mobile delivery mechanisms each being dimensioned and arranged to receive an item at the input station and each being movable along paths encompassing the input station and a corresponding target storage location of the plurality of storage locations; and
a controller for controlling movements of the mobile delivery mechanisms along paths adjacent to the plurality of storage locations;
wherein each delivery mechanism includes
a transfer mechanism defining a carrying surface dimensioned and arranged to receive an item to be delivered at the station and to support the item to be delivered as the delivery mechanism moves along a respective path to a corresponding target storage location,
a first lateral wall extending along a first side of the carrying surface, and
a second lateral wall extending along a second side of the carrying surface and opposing the first wall so that a first transfer passage is formed proximate a first end of the support and a second transfer passage is formed proximate a second end of the support,
a retention assistant comprising a first retention assistant wall and a second retention assistant wall,
the first retention assistant wall being dimensioned and arranged to extend transversely relative to the first and second lateral walls and displaceable between a first position substantially closing the first transfer passage to thereby prevent an item on the carrying surface from moving into and through the first transfer passage and a second position permitting movement of an item to be delivered into and through the first discharge opening, and
the second retention assistant wall being disposed transverse to the first and second lateral wall surfaces, spaced apart from the first retention assistant wall, and being one of non-manipulable out of a position impeding movement of an item out of the retention zone or displaceable from a first position substantially closing the second transfer passage to thereby prevent an item on the carrying surface from moving into and through the second transfer passage to a second position; and
a motor controllable to transfer a first item from the carrying surface of the transfer mechanism to the first storage location while the first retention assistant wall is in the second position.

43. The system according to claim 42, wherein each mobile delivery mechanism is a delivery vehicle, wherein the motor of each delivery vehicle is a first motor and wherein the delivery vehicle further includes a second motor operative to drive the delivery vehicle along a path from the input station to a target delivery location, and wherein the first and second lateral walls and the retention assistant are dimensioned and arranged such that an item disposed on the carrier surface of the delivery vehicle is free to move upon the carrying surface but is confined to the boundaries of the retention zone despite changes in at least one of delivery vehicle direction of travel or delivery vehicle rate of travel.

44. The system according to claim 43, wherein each path traveled by a delivery vehicle of the plurality of delivery vehicles is a vertical loop path which encompasses a position proximate the input station and a position proximate a target storage location of a plurality of storage locations, and wherein the input station includes an feed conveyor operatable to feed items to the delivery mechanism, wherein the second retention assistant wall is displaceable from the first position to a second position permitting movement of an item to be delivered into and through the second transfer passage, and wherein the first motor is further controllable to transfer an item out of the retention zone and into a target storage location while the second retention assistant wall is in the second position.

45. The system according to claim 43, wherein the transfer mechanism includes an endless belt looped around a pair of rollers, wherein the retention zone is defined by an upwardly facing surface portion of the endless belt, and wherein the first motor is controllable to advance the endless belt in at least one of the first transfer direction or the second transfer direction.

46. The system according to claim 45, wherein the first and second retention assistant walls are defined by first and second elongated cleats which are separated from one another by a distance sufficient to form, with the lateral wall surfaces, an item retention zone, and wherein displacement of the first retention assistant wall into the first position includes actuating the first motor to advance the endless belt such that the first and second elongated cleats are upwardly facing and define boundaries of the retention zone transverse to the first and second transfer directions.

47. The system according to claim 46, wherein the first and second retention assistant walls define surfaces which extend from the endless belt by a distance of from about 0.5 cm to about 3.75 cm.

48. The system according to claim 46, wherein the first and second retention assistant walls define surfaces which are substantially orthogonal to a plane defined by a portion of the carrying surface.

49. The system according to claim 46, wherein the first and second retention assistant walls define inwardly facing surfaces bounding the retention zone and disposed in planes that converge relative to one another so as to form acute angles relative to the carrying surface, whereby an irregular item having a tendency to shift upon the carrying surface during positioning onto or travel of the delivery vehicle is more likely to contact a portion of a retention assistant wall located further from the carrying surface than a portion of the first or second retention assistant located closer to the carrying surface.
